(19) United States
(12) Patent Application Publication
(10) Pub. No.: US 2025/0117610 A1
(43) Pub. Date: Apr. 10, 2025

(54) PRINTING APPARATUS, METHOD FOR CONTROLLING PRINTING APPARATUS, AND STORAGE MEDIUM

(71) Applicant: CANON KABUSHIKI KAISHA, Tokyo (JP)

(72) Inventors: YASUHIRO TAKAHASHI, Chiba (JP); NORITSUGU OKAYAMA, Tokyo (JP)

(21) Appl. No.: 18/883,929

(22) Filed: Sep. 12, 2024

(30) Foreign Application Priority Data
Sep. 21, 2023 (JP) 2023-155560

(51) Int. Cl. G06K 15/16; G03G 15/00; G06K 15/00

(52) U.S. Cl. CPC G06K 15/16; G03G 15/502; G03G 15/6508; G06K 15/002; G06K 15/4065; G06K 15/408

(57) ABSTRACT

An image forming apparatus enables changing a sheet feed stage for job separator sheets during a print job in a case where the sheet feed stage to be used as the sheet feed stage for the job separator sheets is reserved and the print job is configured to not use a reserved sheet feed stage.

### BACKGROUND

### Field

The present disclosure relates to a printing apparatus, a method for controlling a printing apparatus, and a storage medium.

### Description of the Related Art

Japanese Patent Application Laid-Open No. 2019-93556 discusses temporarily reserving a holding unit that holds sheets for printing (for example, a sheet feed cassette where sheets are stacked) so that the sheets held in the holding unit are not used for print jobs of other users.

According to the technique discussed in Japanese Patent Application Laid-Open No. 2019-93556, in a case where, for example, a reserved holding unit is specified as a holding unit that holds separator sheets for separating print jobs, the use of separator sheets is not permitted in normal print jobs. In such a case, separator sheets can fail to be fed from the holding unit. As a result, the print jobs may become unable to continue. This forces users to cancel the print jobs.

### SUMMARY

The present disclosure is directed to preventing situations where print jobs become unable to continue.

According to an aspect of the present disclosure, a printing apparatus includes a sheet holding unit, a first setting unit configured to set the sheet holding unit as a sheet feed source of a separator sheet, a second setting unit configured to set a setting on the sheet holding unit to restrict use of a sheet held therein, an execution unit configured to execute a print job, and a display unit configured to, in a case where the execution unit executes the print job in a state where the setting by the second setting unit is set on the sheet holding unit set as the sheet feed source of the separator sheet by the first setting unit, display a screen configured to change the sheet feed source of the separator sheet.

Further features of the present disclosure will become apparent from the following description of exemplary embodiments with reference to the attached drawings.

### BRIEF DESCRIPTION OF THE DRAWINGS

FIGS. 1A and 1B are diagrams illustrating a configuration of an image forming apparatus.

FIG. 2 is a diagram illustrating an image forming system.

FIG. 3 is a diagram illustrating functional blocks of a sheet feed section of the image forming apparatus.

FIG. 4 is a flowchart illustrating a method for reserving a sheet feed stage and setting job separator sheets.

FIG. 5 is a diagram illustrating a home screen.

FIG. 6 is a diagram illustrating a setting selection screen.

FIG. 7 is a diagram illustrating a sheet setting screen.

FIG. 8 is a diagram illustrating a sheet feed stage reservation setting screen.

FIG. 9 is a diagram illustrating a first example of a job separator sheet setting screen.

FIG. 10 is a diagram illustrating a separator sheet feed location setting screen.

FIG. 11 is a flowchart illustrating printer driver processing.

FIG. 12 is a diagram illustrating a print setting screen.

FIG. 13 is a flowchart illustrating printer processing.

FIG. 14 is a flowchart illustrating page generation processing.

FIG. 15 is a flowchart illustrating print processing.

FIG. 16 is a flowchart illustrating a first example of job separator sheet feed processing.

FIG. 17 is a diagram illustrating a first example of a job separator sheet feed error screen.

FIG. 18 is diagram illustrating a job separator sheet setting change screen.

FIG. 19 is a flowchart illustrating sheet feed determination processing.

FIG. 20 is a diagram illustrating a paper-out error screen.

FIG. 21 is a diagram illustrating a second example of the job separator sheet feed error screen.

FIG. 22 is a diagram illustrating a sheet feed stage reservation setting change screen.

FIG. 23 is a flowchart illustrating a second example of the job separator sheet feed processing.

FIG. 24 is a diagram illustrating a third example of the job separator sheet feed error screen.

FIG. 25 is a flowchart illustrating a first example of sheet feed stage reservation setting processing.

FIG. 26 is a diagram illustrating a first example of sheet feed stage reservation setting screen.

FIG. 27 is a flowchart illustrating job separator sheet setting processing.

FIG. 28 is a diagram illustrating a second example of the job separator sheet setting screen.

FIG. 29 is a diagram illustrating a third example of the job separator sheet setting screen.

FIG. 30 is a diagram illustrating a separator sheet feed location setting screen.

FIG. 31 is a flowchart illustrating a third example of the job separator sheet feed processing.

FIG. 32 is a diagram illustrating a second example of the sheet feed stage reservation setting screen.

FIG. 33 is a diagram illustrating a second example of the sheet feed stage reservation setting processing.

FIG. 34 is a flowchart illustrating a fourth example of the job separator sheet feed processing.

### DESCRIPTION OF THE EMBODIMENTS

Hereinafter, exemplary embodiments of the present disclosure will be described with reference to the drawings. The following exemplary embodiments are not intended to limit the present disclosure according to the appended claims, and all combinations of features described in the exemplary embodiments are not necessarily essential to the means for solving the issues of the present disclosure.

A first exemplary embodiment will initially be described.

An example of an image forming apparatus will initially be described. Examples of the image forming apparatus include a printer, a copying machine, a facsimile, and a multifunction peripheral combining the functions of these. The image forming apparatus has a function of forming an image on a sheet that is a recording medium (print function).

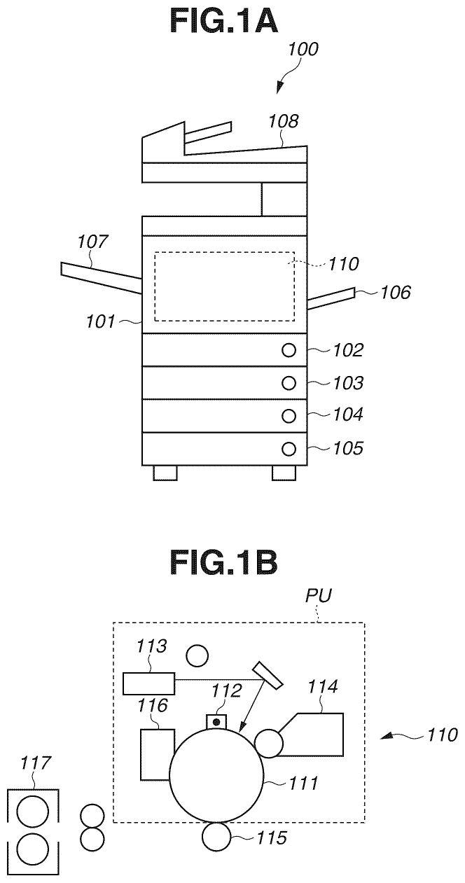

FIG. 1A illustrates a case where an image forming apparatus 100 is a multifunction peripheral that forms an image on a sheet. Examples of the sheet include paper such as a sheet of paper and an envelope, a plastic film such as an overhead projector (OHP) sheet, and cloth. As employed herein and in the drawings, the terms “sheet” and “sheet feed” are regarded as referring to sheets in general including non-paper sheets unless otherwise specified. “Paper” is an example of “sheet”, and “sheet feed” is an example of “feeding”.

The image forming apparatus 100 includes devices such as a printer unit 101, a scanner unit 108, a plurality of sheet feed cassettes 102 to 105, a manual feed tray 106, and a discharge tray 107. The sheet feed cassettes 102 to 105 and the manual feed tray 106 will be referred to as sheet feed stages where appropriate unless distinguished in particular. The sheet feed cassettes 102 to 105, when distinguished, are referred to with numbers like sheet feed cassette 1 to sheet feed cassette 4 where appropriate.

The scanner unit 108 serving as an image reading device optically scans a document and converts the document into electronic image information using charge-coupled device (CCD) photoelectric conversion elements. The printer unit 101 forms an image on a sheet based on image information input from the scanner unit 108 or an external host computer, using a printer engine 110 that is an example of an image forming section.

The sheet feed cassettes 102 to 105 accommodate sheets. The manual feed tray 106 holds sheets placed on the placement surface of the manual feed tray 106. The sheets held in/on the sheet feed cassettes 102 to 105 and the manual feed tray 106 are separated one by one and fed to the printer engine 110 by a not-illustrated sheet feed unit. The sheet feed cassettes 102 to 105 and the manual feed tray 106 are all examples of holding units that hold sheets to be supplied to the image forming section. The sheet on which an image is formed by the printer engine 110 is discharged to the discharge tray 107 that is a discharge section.

As illustrated in FIG. 1B, the printer engine 110 includes an electrophotographic image forming unit PU. The image forming unit PU includes a photosensitive drum 111 that is a drum-shaped photosensitive member, a charging device 112, an exposure device 113, a developing device 114, and a cleaning device 116. In response to the printer engine 110 being requested to start an image forming operation, the printer engine 110 performs the following operations. The charging device 112 uniformly charges the surface of the photosensitive drum 111. The exposure device 113 forms an electrostatic latent image on the surface of the photosensitive drum 111 by scanning the photosensitive drum 111 with laser light. The developing device 114 develops the electrostatic latent image into a toner image by supplying charged toner to the photosensitive drum 111. The toner image borne on the photosensitive drum 111 is transferred to a sheet by a transfer device 115. The toner image transferred to the sheet is fixed to the sheet by a thermal fixing device 117, for example.

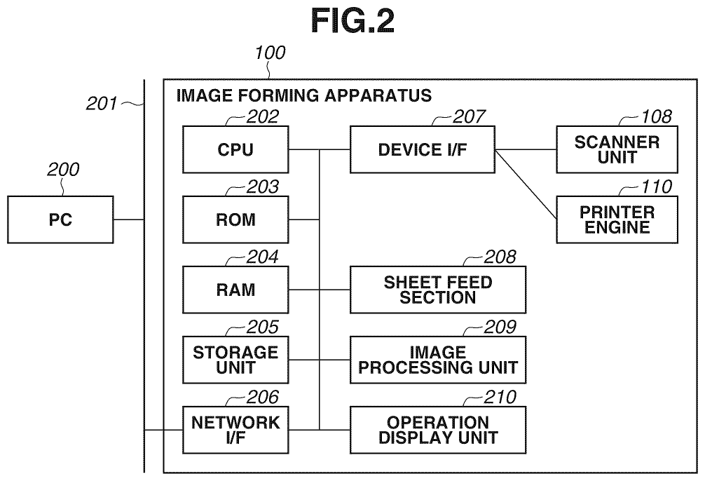

Next, an example of an image forming system including the image forming apparatus 100 will be described with reference to FIG. 2. The image forming apparatus 100 is connected to a wired or wireless network 201 via a network interface (I/F) 206, and communicates with an information processing apparatus such as a personal computer (PC) 200.

A printer driver is installed on the PC 200 as driver software that generates a job (hereinafter, print job) for instructing the image forming apparatus 100 to form images. For example, the printer driver generates a print job described in a page description language (PDL) based on document data received from a document creation application on the PC 200. Examples of the PDL include PostScript (PS), Printer Command Language (PCL), and Laser Beam Printer (LBP) Image Processing System (LIPS) (registered trademark). The PC 200 includes a control unit such as a central processing unit (CPU), and storage units such as a read-only memory (ROM), a random access memory (RAM), and a hard disk drive (HDD), for example. The PC 200 transmits the print job generated using the printer driver to the image forming apparatus 100 via the network 201.

The image forming apparatus 100 is controlled by the CPU 202. The CPU 202 operates based on a program stored in the RAM 204. The ROM 203 is a boot ROM. The ROM 203 stores a system boot program. A storage unit 205 stores system software, image data, and a program for controlling operation of the image forming apparatus 100. The program stored in the storage unit 205 is loaded into the RAM 204, and the CPU 202 controls the operation of the image forming apparatus 100 based on the loaded program. In the following description, each step of the control process of the image forming apparatus 100 is performed by the CPU 202 unless otherwise specified.

The image forming apparatus 100 and the PC 200 may include one or more pieces of dedicated hardware different from their CPU, and the dedicated hardware may perform at least part of the processing by the CPU. Examples of the dedicated hardware include an application-specific integrated circuit (ASIC), a field-programmable gate array (FPGA), and a digital signal processor (DSP). The image forming apparatus 100 and the PC 200 may include a hardware processor (such as a graphics processing unit [GPU]) other than the CPU instead of or in addition to the CPU.

An image processing unit 209 performs image processing on image data. For example, the image processing unit 209 performs image processing on image data received via the network I/F 206. The image processing unit 209 performs image processing on image data input or output to/from a device I/F 207. Image data transmitted from the PC 200 is converted into raster image data by the image processing unit 209 and stored in the storage unit 205. The image data stored in the storage unit 205 is transmitted to the printer engine 110 as a video signal via the device I/F 207, and used for the image forming operation by the printer engine 110.

The image forming apparatus 100 includes an operation display unit 210 that displays information to the user and accepts instructions from the user. For example, the operation display unit 210 includes a screen display unit including a display such as a liquid crystal display (LCD). For example, the operation display unit 210 includes a touchscreen that is installed on the display and functions as software keys for receiving an input of user operation based on a relationship between the positions of operation items displayed on the display and the position of the user operation on the display. For example, the operation display unit 210 includes an operation input unit including hardware keys such as a numeric keypad. Display processing for displaying information on the operation display unit 210 is performed by the CPU 202, for example.

The CPU 202 of the image forming apparatus 100 further controls a sheet feed section 208. The present exemplary embodiment deals with a case where the sheet feed section 208 includes the sheet feed stages such as the sheet feed cassettes 102 to 105 and the manual feed tray 106.

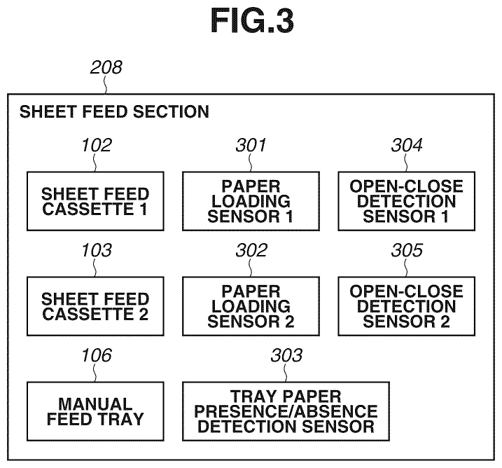

FIG. 3 is a functional block diagram illustrating an example of the sheet feed section 208 of the image forming apparatus 100 in detail. The sheet feed section 208 supplies sheets to the printer engine 110. The CPU 202 controls the sheet feed cassettes 1 to 4 (102 to 105) and the manual feed tray 106 in the sheet feed section 208 to feed sheets (perform sheet feeding) from the sheet feed stages, i.e., the sheet feed cassettes 1 to 4 (102 to 105) and the manual feed tray 106.

The sheet feed cassettes 1 and 2 (102 and 103) are equipped with paper load sensors 301 and 302 that detect how much paper is loaded in the respective sheet feed cassettes 1 and 2. The CPU 202 can thereby detect that there is currently no paper in the sheet feed cassettes 1 and 2 or, in a case where there is paper, how much paper is loaded in the sheet feed cassettes 1 and 2. The sheet feed cassettes 1 and 2 (102 and 103) are also equipped with open-close detection sensors 304 and 305 for detecting the open or closed state of the sheet feed cassettes 1 and 2 (102 and 103), respectively. The CPU 202 can thereby detect the opening and closing of the respective sheet feed cassette 1 and 2 (102 and 103) in real time as an event from the open-close detection sensors 304 and 305. The sheet feed cassettes 3 and 4 (104 and 105) are similarly equipped with paper load sensors and open-close detection sensors, which are omitted in FIG. 3.

The manual feed tray 106 is equipped with a tray paper presence/absence detection sensor 303 for detecting whether paper is loaded on the manual feed tray 106. The CPU 202 can thereby detect the loading of paper on the manual feed tray 106 and the removal of paper from the manual feed tray 106 in real time as an event from the tray paper presence/absence detection sensor 303.

### (Overview of Processing for Forming Image)

An example of an overview of the processing for forming an image will be described.

The present exemplary embodiment deals with a case where a sheet feed stage is reserved and job separator sheets are set before execution of the processing for forming an image. Reserving a sheet feed stage refers to a setting to restrict use of the sheet feed cassette or manual feed tray where sheets to be used for image formation are loaded.

During the reservation period, the use of the reserved sheet feed stage is in principle permitted for print jobs of the user who has performed the reservation, and prohibited for print jobs of other users. Details of the reservation of the sheet feed stage will be described below. A job separator sheet is a sheet of a sheet feed stage specified by a print job and inserted as the first page of the print job. The insertion of the job separator sheet as the first page of the print job can separate printed documents in printing documents of a plurality of print jobs in succession. The job separator sheet may be inserted as the last page instead of or in addition to the first page. An example of the method for setting job separator sheets will be described below.

The PC 200 then generates a print job through printer driver processing, and outputs the print job to the image forming apparatus 100. When the print job is input, the image forming apparatus 100 performs printer processing to process the print job.

Next, details of each process will be described.

### (Reservation of Sheet Feed Stage)

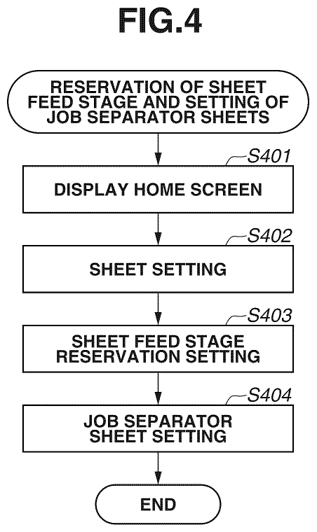

An example of the setting for reserving a sheet feed stage and an example of the setting of job separator sheets will be described with reference to the flowchart of FIG. 4. A description will be given using an example where the user loads the following special sheets in the sheet feed cassette 102 and performs the operation of reserving the sheet feed cassette 102 for use:
Sheet size: A4, and
Sheet type: color paper.

The user initially loads the foregoing special sheets into the sheet feed cassette 102. The user then operates the operation display unit 210 of the image forming apparatus 100 to set the size and type of the sheets loaded in the sheet feed cassette 102.

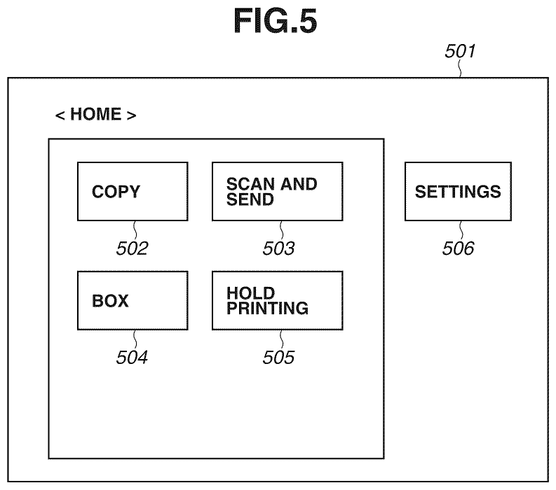

In step S401, the CPU 202 of the image forming apparatus 100 displays a home screen 501 illustrated in FIG. 5 on the operation display unit 210, and waits for the user's input operation on the home screen 501. FIG. 5 illustrates a case where the home screen 501 includes function selection buttons 502 to 505 and a setting start button 506. The function selection button 502 is a button to be selected when the user uses a copy function. The function selection button 503 is a button to be selected when the user users a transmission function. The function selection button 504 is a button to be selected when the user uses a box function. The function selection button 505 is a button to be selected when the user uses a hold printing function. The setting start button 506 is a button to be selected to set various settings of the image forming apparatus 100.

In the following description, selecting various buttons is synonymous with pressing the buttons. Graphical user interface (GUI) components on the screens illustrated in the drawings are just examples. The GUI components are not limited to those illustrated on the screens as long as the GUI components can play the similar roles as those of the GUI components illustrated on the screens.

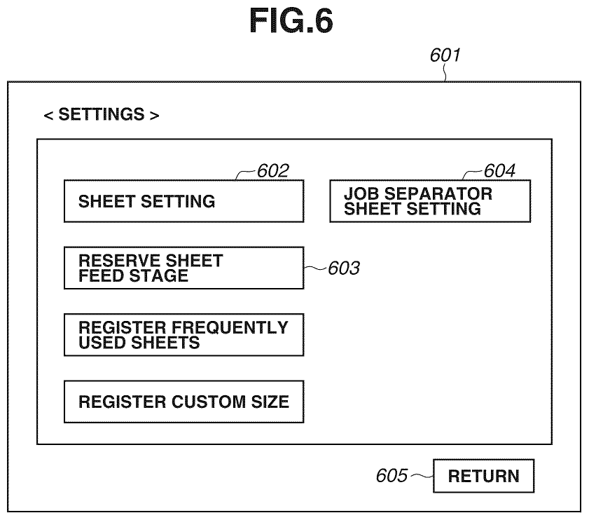

The present exemplary embodiment deals with a case where the user selects the setting start button 506 when setting the size and type of sheets loaded in a sheet feed stage and reserving the sheet feed stage for use. In response to detection of the setting start button 506 being selected, the CPU 202 of the image forming apparatus 100 displays a setting selection screen 601 illustrated in FIG. 6 on the operation display unit 210. The setting selection screen 601 is a screen for the user to select various setting items.

FIG. 6 illustrates a case where the setting selection screen 601 includes buttons such as setting selection buttons 602 to 604 and a return button 605. The setting selection button 602 is a button to be selected when the user sets sheet settings. The setting selection button 603 is a button to be selected when the user makes sheet feed stage reservation settings. The setting selection button 604 is a button to be selected when the user sets job separator sheet settings to be described below. The return button 605 is a button to be selected to restore the display to the home screen 501.

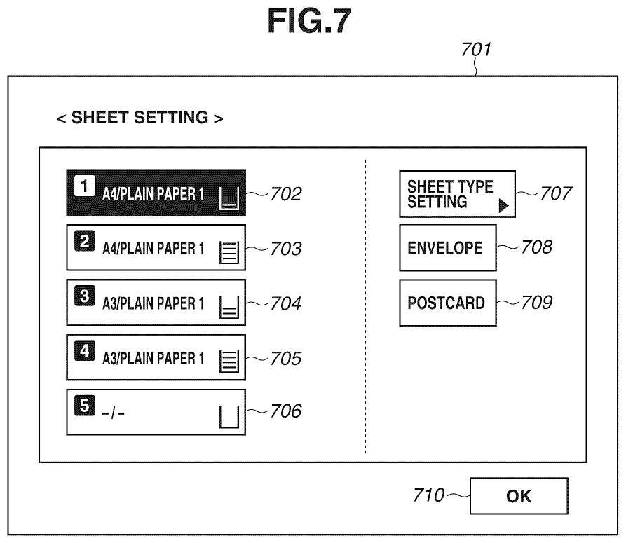

In response to the CPU 201 detecting that the setting selection button 602 for sheet settings is pressed among the various setting items (buttons on the setting selection screen 601), then in step S402, the CPU 201 displays a sheet setting screen 701 illustrated in FIG. 7 on the operation display unit 210. FIG. 7 illustrates a case where the sheet setting screen 701 includes sheet feed stage selection buttons 702 to 706. In FIG. 7, the setting statuses of the sheet feed stages corresponding to the sheet feed stage selection buttons 702 to 706 are displayed on the respective sheet feed stage selection buttons 702 to 706. An example of the display content of the sheet feed stage selection buttons 702 to 706 will be described below.

FIG. 7 illustrates a case where the sheet setting screen 701 includes a type setting button 707, size setting buttons 708 and 709, and an OK button 710. The type setting button 707 is a button to be selected when the user changes the sheet type. The size setting buttons 708 and 709 are buttons to be selected when the user sets the sheet size to a special size (envelope size or postcard size). The type setting button 707 and the size setting buttons 709 and 710 become operable after one of the sheet feed stage selectin buttons 702 to 706 is selected. The OK button 710 is a button to be selected when the user ends the sheet settings using the sheet setting screen 701.

An example of the setting statuses of the sheet setting stages displayed on the respective sheet feed stage selection buttons 702 to 706 will now be described in detail.

The setting statuses of the sheet feed stages are stored in the storage unit 205 of the image forming apparatus 100 as sheet feed stage information, using information such as illustrated in the following Table 1, for example:

TABLE 1

| | | | Remaining | |
|---|---|---|---|---|
| | Sheet | | sheet | Reservation |
| Sheet feed stage | size | Sheet type | level | state |
| Sheet feed cassette 1 | A4 | plain paper 1 | 25% | — |
| Sheet feed cassette 2 | A4 | plain paper 1 | 100% | — |
| Sheet feed cassette 3 | A3 | plain paper 1 | 50% | — |
| Sheet feed cassette 4 | A3 | plain paper 1 | 100% | — |
| Manual feed tray | N/A | N/A | 0% | — |

In Table 1, the sheet size is the size of sheets automatically detected or set by the user when each sheet feed stage is loaded with the sheets. The sheet type is the type of the sheets set by selecting the type setting button 707. The remaining sheet level indicates the remaining level detected by each sheet feed stage in five grades. The reservation state in Table 1 indicates the reservation states of the sheet feed stages. The present exemplary embodiment deals with a case where the reservation states are set by selecting the setting selection button 603 illustrated in FIG. 6. Table 1 illustrates a case where all the reservation state fields are empty, i.e., all the sheet feed stages can be used by any user. An example of the method for reserving a sheet feed stage for use by selecting the setting selection button 603 will be described below.

Next, an example of the operation of the image forming apparatus 100 when a sheet feed stage is selected and the type setting button 707 is selected will be described. For the purpose of description, in the present exemplary embodiment, the sheet feed stage selection button 702 corresponding to the sheet feed cassette 102 is selected and then the type setting button 707 is selected. The CPU 202 of the image forming apparatus 100 detects the selection of the type setting button 707, and displays a not-illustrated sheet type setting screen on the operation display unit 210. The CPU 202 then waits until a sheet type is selected (determined) from a plurality of sheet types by the user's input operation on the sheet type setting screen. When a sheet type is selected, the CPU 202 updates the sheet feed stage information based on the sheet type and completes the sheet type setting. In the present exemplary embodiment, color paper is selected as the sheet type.

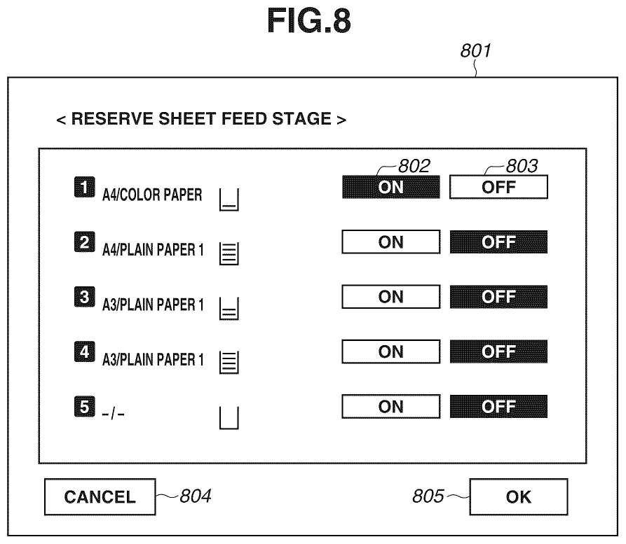

Next, an example of the operation for reserving a sheet feed stage for use will be described. For the purpose of description, in the present exemplary embodiment, the sheet feed cassette 102 is reserved for use. To reserve a sheet feed stage for use, the setting selection button 603 on the foregoing setting selection screen 601 is used. As described above, the setting selection button 603 is a button to be selected when the user sets sheet feed stage reservation settings. In response to the CPU 202 detecting the selection of the setting selection button 603 for sheet feed stage reservation settings, then in step S403, the CPU 202 displays a sheet feed stage reservation setting screen 801 illustrated in FIG. 8 on the operation display unit 210. FIG. 8 illustrates a case where the sheet feed stage reservation setting screen 801 includes reservation ON buttons 802, reservation OFF buttons 803, a cancel button 804, and an OK button 805.

The reservation ON buttons 802 are buttons provided for the respective sheet feed stages, and selected in a case where the sheet feed stages corresponding to the buttons are reserved for use. The reservation OFF buttons 803 are buttons provided for the respective sheet feed stages, and selected in a case where the sheet feed stages corresponding to the buttons are not reserved for use. The reservation ON button 802 or the reservation OFF button 803 corresponding to the same sheet feed stage is activated (selected).

The cancel button 804 is a button to be selected to cancel the operation for reserving a sheet feed stage for use (input operation performed on the sheet feed stage reservation setting screen 801). The OK button 805 is a button to be selected to finalize the reservation of the sheet feed stage for use (input operation performed on the sheet feed stage reservation setting screen 801).

FIG. 8 illustrates a case where the sheet feed cassette 1 (102) is reserved by selecting the reservation ON button 802 corresponding to the sheet feed cassette 1 (102). In response to the CPU 202 detecting that the OK button 805 for finalizing the reservation is selected by the user in this state, the CPU 202 records “reserved” into the reservation state field corresponding to the sheet feed cassette 1 (102) among the reservation stage fields of the sheet feed stage information stored in the storage unit 205. This enables the sheet feed cassette 1 (102) to feed sheets only for print jobs that are set to use a sheet feed stage reserved for use in step S1105 to be described below. In cancelling the use reservation of a sheet feed stage, the user selects the reservation OFF button 803 to cancel the reservation on the sheet feed stage reservation setting screen 801 again and selects the OK button 805. The CPU 202 then clears the reservation state field corresponding to this reservation OFF button 803 among the reservation state fields of the sheet feed stage information stored in the storage unit 205. A specific example of the sheet feed operation on the reserved sheet feed stage will be described below in conjunction with sheet feed determination processing.

Table 2 illustrates what are changed in the sheet feed stage information illustrated in Table 1 by the change in the sheet type and the use reservation of the sheet feed stage. For easy comparison with Table 1, Table 2 illustrates the items changed from Table 1 in uppercase letters.

TABLE 2

| | | | Remaining | |
|---|---|---|---|---|
| | Sheet | | sheet | Reservation |
| Sheet feed stage | size | Sheet type | level | state |
| Sheet feed cassette 1 | A4 | COLOR PAPER | 25% | RESERVED |
| Sheet feed cassette 2 | A4 | plain paper 1 | 100% | — |
| Sheet feed cassette 3 | A3 | plain paper 1 | 50% | — |
| Sheet feed cassette 4 | A3 | plain paper 1 | 100% | — |
| Manual feed tray | N/A | N/A | 0% | — |

### (Job Separator Sheet Settings)

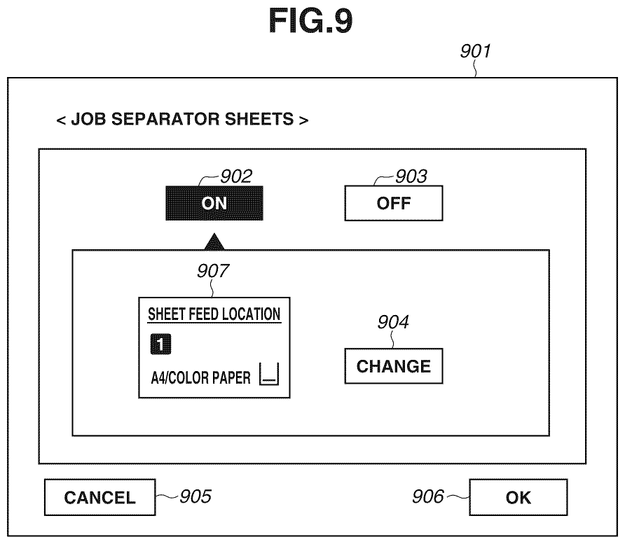

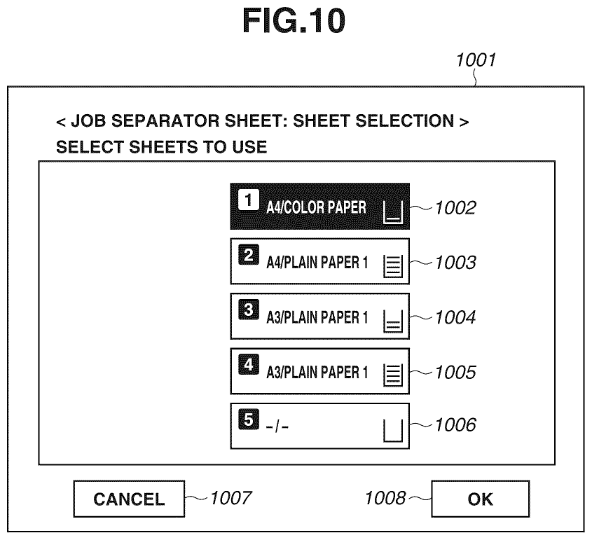

Next, an example of the method for setting job separator sheets (step S404) will be described with reference to FIGS. 9 and 10.

In response to the CPU 202 detecting that the setting selection button 604 on the foregoing setting selection screen 601 is selected, the CPU 202 displays a job separator sheet setting screen 901 illustrated in FIG. 9 on the operation display unit 210. FIG. 9 illustrates a case where the job separator sheet setting screen 901 includes a setting ON button 902, a setting OFF button 903, a sheet feed stage setting button 904, a cancel button 905, and an OK button 906.

The setting ON button 902 is a button to be selected to enable the job separator sheet settings. The setting OFF button 903 is a button to be selected to disable the job separator sheet settings. In response to a selection of the setting ON button 902 for enabling the job separator sheet settings, the sheet feed stage setting button 904 for setting the sheet feed stage to be used for job separator sheets becomes operable. A sheet feed stage current status display field 907 displays information indicating the sheet feed stage where job separator sheets are currently set.

The cancel button 905 is a button to be selected to cancel the job separator sheet settings (input operation performed on the job separator sheet setting screen 901). The OK button 906 is a button to be selected to finalize the job separator sheet settings (input operation performed on the job separator sheet setting screen 901). In response to the CPU 202 detecting the selection of the OK button 906, the CPU 202 finalizes the job separator sheet settings based on the input operation performed on the job separator sheet setting screen 901.

To change the job separator sheet settings, the sheet feed stage setting button 904 is selected. In response to the CPU 202 detecting the selection of the sheet feed stage setting button 904, the CPU 202 displays a separator sheet feed location setting screen 1001 illustrated in FIG. 10 on the operation display unit 210. FIG. 10 illustrates a case where the separator sheet feed location setting screen 1001 includes sheet feed stage selection buttons 1002 to 1006, a cancel button 1007, and an OK button 1008.

FIG. 10 illustrates a case where the setting statuses of the sheet feed stages (sheet feed locations) corresponding to the sheet feed stage selection buttons 1002 to 1006 are displayed on the respective sheet feed stage selection buttons 1002 to 1006. The user selects one of the sheet feed stage selection buttons 1002 to 1006, whereby the sheet feed stage corresponding to the selected button can be selected (changed) as the sheet feed stage where sheets to be used as job separator sheets are held.

The cancel button 1007 is a button to be selected to cancel the operation for setting the sheet feed stage where the sheets to be used as job separator sheets are held (input operation performed on the separator sheet feed location setting screen 1001). The OK button 1008 is a button to be selected to finalize the sheet feed stage where the sheets to be used as job separator sheets are held (input operation performed on the separator sheet feed location setting screen 1001). In response to detection of the selection of the OK button 1008, the CPU 202 determines (changes) the sheet feed stage for job separator sheets.

### (Printer Driver Processing)

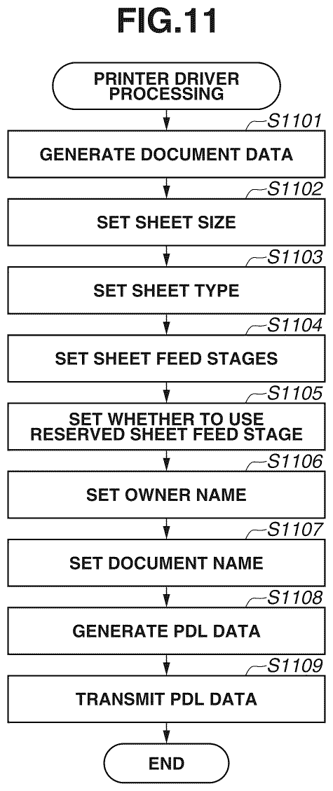

Next, an example of the printer driver processing will be described with reference to the flowchart of FIG. 11. The following steps are implemented, for example, by the CPU or other control unit of the PC 200 executing the program constituting the printer driver. The printer driver processing is started when the user of the PC 200 performs an operation to instruct the document creation application to print, for example. In the present exemplary embodiment, document data representing the content (text or figures) to be printed is generated in step S1101 in advance, using the document creation application.

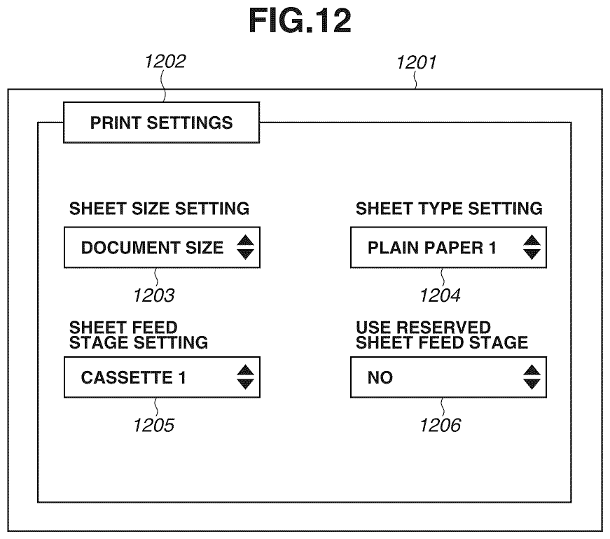

In steps S1102 to S1105, the PC 200 performs setting processing for setting attribute information about the print job based on the user's input operations on the PC 200. Specifically, as illustrated in FIG. 12, the PC 200 displays a print setting screen 1201 for setting print conditions on a computer display, and enters a state for accepting the user's input operations on the print setting screen 1201. A tab 1202 displays that this screen is intended to set print settings. A sheet size setting field 1203 displays the setting value of the sheet size. A sheet type setting field 1204 displays the setting value of the sheet type. A sheet feed stage setting field 1205 displays the sheet feed stage specified as a sheet source.

Examples of the sheet size selectable in the sheet size setting field 1203 include “document size” that specifies the same size as that of the document data, standard sizes such as “A4”, and a user-defined size that the user numerically inputs (step S1102). Examples of the sheet type selectable in the sheet type setting field 1204 include setting values such as “plain paper 1” and “plain paper 2” with higher grammage than “plain paper 1” (step S1103). In the sheet feed stage setting field 1205, one of the sheet feed cassettes 102 to 105 and the manual feed tray 106 can be selected as the sheet feed stage (step S1104).

The sheet types (sheet type setting field 1204) and the sheet feed stages (sheet feed stage setting field 1205) can both include an option “auto” to leave the selection up to the image forming apparatus 100. In a reserved sheet feed stage use setting field 1206, whether to use sheets loaded in a sheet feed stage reserved for use can be selected (step S1105). The user can print using the sheets loaded in the sheet feed stage reserved for use by selecting “yes” in the reserved sheet feed stage use setting field 1206. In the following description, the sheet feed stage reserved for use can be referred to as a reserved sheet feed stage where appropriate.

Based on such input operations performed by the user on the print setting screen 1201, the PC 200 sets the sheet size in step S1102, the sheet type in step S1103, the sheet feed stage to serve as a sheet source in step S1104, and whether to use a reserved sheet feed stage in step S1105.

In steps S1106 and S1107, the PC 200 sets the owner name and document name of the print job. The owner name is information for identifying the user who generates the print job. The present exemplary embodiment deals with a case where the owner name is the identifier (ID) of the user currently logged in to the PC 200. The document name is information for identifying the data file of the document or drawings to be printed. The present exemplary embodiment deals with a case where the document name is obtained from the application that generates the document data.

In step S1108, the PC 200 generates PDL data compliant with the PDL format as a print job based on the document data and various types of setting information. The PDL data includes page data expressing the drawing content of each page and the setting information about the print job. Examples of the setting information about the print job include the sheet size, the sheet type, sheet feed stage setting information (information about the sheet feed stage for use in printing), the owner name, and the document name.

The present exemplary embodiment deals with a case where the setting information about the print job includes setting information about whether to use a reserved sheet feed stage. The page data is image information generated from the document data by the printer driver in compliance with the PDL format. In step S1109, the PC 200 transmits the PDL data to the image forming apparatus 100 via the network 201.

### (Printer Processing)

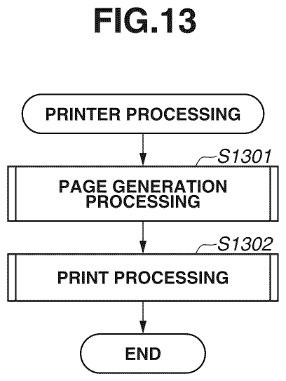

When the PDL data reaches the image forming apparatus 100, the CPU 202 of the image forming apparatus 100 starts the printer processing. As illustrated in FIG. 13, the printer processing broadly includes page generation processing (step S1301) for generating image data page by page and print processing (step S1302) for forming images on sheets based on the image data.

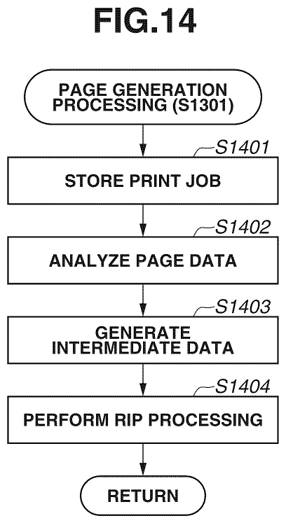

An example of the page generation processing in step S1301 of FIG. 13 will initially be described with reference to the flowchart of FIG. 14.

In step S1401, the CPU 202 temporarily stores the print job transmitted from the PC 200 as the PDL data into the storage unit 205. The print job stored in the storage unit 205 includes the page data as image information compliant with the PDL format. In step S1402, the CPU 202 analyzes the page data. In step S1403, the CPU 202 converts the page data into intermediate data. For example, the intermedia data refers collectively to drawing objects such as bitmaps, run lengths, trapezoids, boxes, and fast boundary-encoded bitmaps, background patterns, and the drawing logic for drawing images of raster format from these elements. The CPU 202 extracts the setting information about the print job, such as the sheet size, included in the PDL data, and stores the setting information in the storage unit 205.

In step S1404, the image processing unit 209 performs raster image processing (RIP) on the intermediate data and stores the resulting data in the storage unit 205. The RIP processing refers to processing for generating raster image data from image data such as vector images.

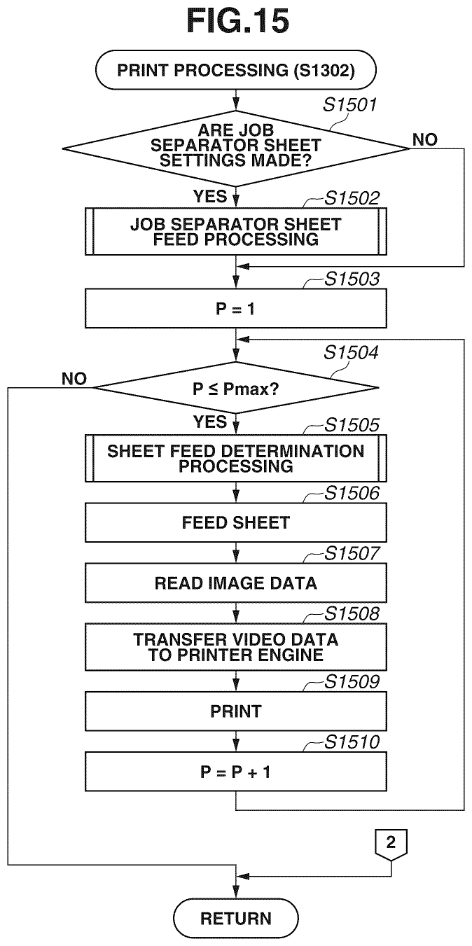

Next, an example of the print processing in step S1302 of FIG. 13 will be described with reference to the flowchart of FIG. 15.

When the print processing is started, in step S1501, the CPU 202 determines whether the job separator sheet settings are set. The job separator sheet settings are set by selecting the setting selection button 604 on the foregoing setting selection screen 601. The job separator sheet settings are set based on the user's input operations on the job separator sheet setting screen 901 and the separator sheet feed location setting screen 1001.

In a case where the determination result of step S1501 indicates that the job separator sheet settings are set (YES in step S1501), the processing proceeds to step S1502. In step S1502, the CPU 202 performs job separator sheet feed processing. The processing then proceeds to step S1503. An example of the job separator sheet feed processing will be described below. On the other hand, in a case where the determination result of step S1501 indicates that the job separator sheet settings are not set (NO in step S1501), the processing of step S1502 is skipped and the processing proceeds to step S1503.

In step S1503, the CPU 202 initializes a parameter P indicating the page being processed (current sheet). The parameter P is an integer value satisfying P≥1. In step S1504, the CPU 202 determines whether the parameter P exceeds a variable Pmax indicating the total number of pages (number of sheets specified by the print job). In a case where the determination result of step S1504 indicates that P≤Pmax (YES in step S1504), the processing proceeds to step S1505 and the CPU 202 repeats the subsequent processing (steps S1505 to S1510). The variable Pmax is extracted by the analysis of the PDL data and stored in the storage unit 205.

In step S1505, the CPU 202 refers to the storage unit 205, obtains the sheet feed stage setting information specified in the sheet feed stage setting field 1205 (see step S1104 of FIG. 11), and performs sheet feed determination processing using the obtained sheet feed stage setting information. The sheet feed determination processing is processing for determining whether sheets can be fed from the sheet feed stage specified as the sheet source. An example of the sheet feed determination processing will be described below. In a case where the result of the sheet feed determination processing indicates that sheets can be fed from the sheet feed stage specified as the sheet source, then in step S1506, the CPU 202 feeds a sheet from the sheet feed stage specified as the sheet source. In step S1507, the CPU 202 reads the image data to be formed on the sheet being processed from the storage unit 205. In step S1508, the CPU 202 converts the image data into video data and transfers the video data to the printer engine 110. In step S1509, the printer engine 110 performs print processing (image formation step) on the sheet based on the video data. In step S1510, the CPU 202 increments the parameter P. The processing returns to step S1504.

In a case where the determination result of step S1504 indicates that P≤Pmax does not hold (NO in step S1504), images have been formed on sheets as many as specified by the print job (total number of pages [Pmax]), and the print processing of step S1302 in FIG. 13 ends.

### (Job Separator Sheet Feed Processing)

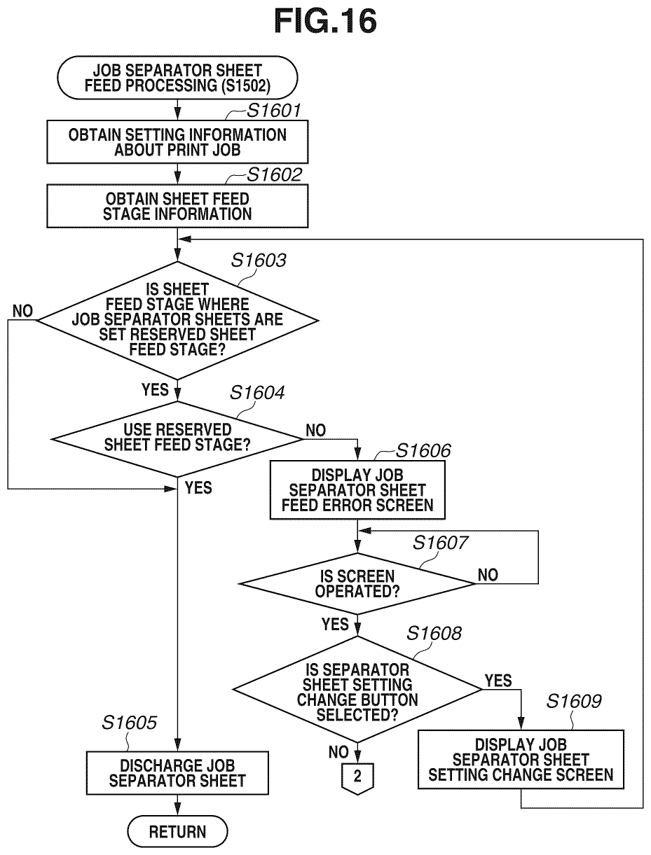

Next, an example of the job separator sheet feed processing in step S1502 of FIG. 15 will be described with reference to the flowchart of FIG. 16.

When the job separator sheet feed processing is started, in step S1601, the CPU 202 obtains the setting information about the print job, stored in the storage unit 205. The setting information about the print job is stored in the storage unit 205 by the processing of step S1402. As described above, the setting information about the print job includes the size of the sheets for printing, the sheet type, the sheet feed stage setting information, and the information about whether to use a reserved sheet feed stage.

In step S1602, the CPU 202 obtains sheet feed stage information stored in the storage unit 205. The sheet feed stage information refers to the setting information about each sheet feed stage, such as illustrated in Table 2. In step S1603, the CPU 202 determines whether the sheet feed stage where job separator sheets are set is a reserved sheet feed stage, based on the sheet feed stage information. In a case where the determination result of step S1603 indicates that the sheet feed stage where job separator sheets are set is not a reserves sheet feed stage (NO in step S1603), the processing of step S1604 is skipped and the processing proceeds to step S1605. In step S1605, the CPU 202 feeds a sheet held in the sheet feed stage where job separator sheets are set as a job separator sheet. The printer engine 110 discharges the sheet fed from the sheet feed stage to the discharge tray 107. The present exemplary embodiment deals with a case where the printer engine 110 simply conveys the sheet (job separator sheet) without forming an image on the sheet. However, an image can be formed on the sheet.

On the other hand, in a case where the determination result of step S1603 indicates that the sheet feed stage where job separator sheets are set is a reserved sheet feed stage (YES in step S1603), the processing proceeds to step S1604. In step S1604, the CPU 202 determines whether the print job is a print job that uses a reserved sheet feed stage, based on the setting information about whether to use a reserved sheet feed stage, included in the setting information about the print job obtained in step S1601. In the example illustrated in the foregoing Table 2 and FIG. 8, the sheet feed cassette 1 (102) where color paper is set is reserved. In the example illustrated in FIGS. 9 and 10, the sheet feed cassette 1 (102) is set by the job separator sheet settings. In such a case, the processing of step S1604 is performed.

In a case where the determination result of step S1604 indicates that the print job about which the setting information is obtained in step S1601 is a print job that uses a reserved sheet feed stage (YES in step S1604), the processing proceeds to step S1605. In the foregoing example, in step S1604, job separator sheets are determined to be able to be fed from the sheet feed cassette 1 (102) that is reserved, and the processing proceeds to step S1605.

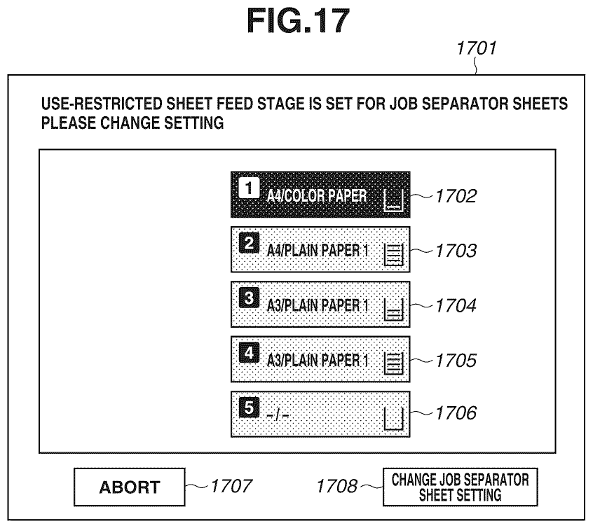

On the other hand, in a case where the determination result of step S1604 indicates that the print job about which the setting information is obtained in step S1601 is not a job that uses a reserves sheet feed stage (NO in step S1604), the processing proceeds to step S1606. In step S1606, the CPU 202 displays a job separator sheet feed error screen 1701 illustrated in FIG. 17 on the operation display unit 210 since job separator sheets are unable to be fed from the sheet feed cassette 1 (102) that is reserved.

FIG. 17 illustrates a case where the job separator sheet feed error screen 1701 includes sheet feed stage selection buttons 1702 to 1706, an abort button 1707, and a separator sheet setting change button 1708. The sheet feed stage selection buttons 1702 to 1706 are buttons for selecting the sheet feed stages. In FIG. 17, the sheet feed stage selection button 1702 for selecting the sheet feed cassette 1 (102) is the button corresponding to the sheet feed stage where job separator sheets are set, and is thus selected. However, as described above, since this sheet feed stage is reserved, the sheet feed stage selection button 1702 is grayed out to indicate inoperability. The sheet feed stages corresponding to the other sheet feed stage selection buttons 1703 to 1706 are not a sheet feed stage where job separator sheets are set. The sheet feed stage selection buttons 1703 to 1706 are therefore also grayed out to indicate inoperability.

The present exemplary embodiment deals with a case where the user can perform either the following operation (I) or operation (II) on the job separator sheet feed error screen 1701:
(I) Select the separator sheet setting change button 1708 to give instructions to change the sheet feed stage to be used for job separator sheets to an unreserved one and continue the print job, considering that the specification of the reserved sheet feed stage as the sheet feed stage for job separator sheets is erroneous; and
(II) Select the abort button 1707 to abort the execution of the print job.

In step S1607, the CPU 202 waits for the user to select the abort button 1707 or the separator sheet setting change button 1708. In a case where the selection of the abort button 1707 or the separator sheet setting change button 1708 is detected (YES in step S1607), the processing proceeds to step S1608. In step S1608, the CPU 202 determines the input of the user operation based on the button selected on the job separator sheet feed error screen 1701.

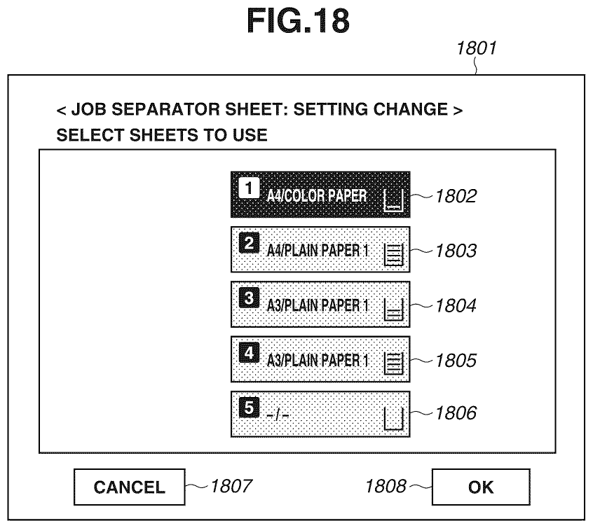

In a case where the separator sheet setting change button 1708 for changing the job separator sheet settings is selected (YES in step S1608), the CPU 202 determines that the user instruction is the foregoing operation (I), and the processing proceeds to step S1609. In step S1609, the CPU 202 displays a job separator sheet setting change screen 1801 illustrated in FIG. 18 on the operation display unit 210. FIG. 18 illustrates a case where the job separator sheet setting change screen 1801 includes sheet feed stage selection buttons 1802 to 1806, a cancel button 1807, and an OK button 1808.

The sheet feed stage selection buttons 1802 to 1806 are buttons for selecting the sheet feed stages. In FIG. 18, the sheet feed stage selection button 1802 for selecting the sheet feed cassette 1 (102) is the button corresponding to the sheet feed stage where job separator sheets are set, and is thus selected. However, as described above, since this sheet feed stage is reserved, the sheet feed stage selection button 1802 is grayed out to indicate inoperability.

On the other hand, the sheet feed stage selection buttons 1803 to 1805 for selecting the sheet feed cassettes 2 to 4 (103 to 105) are selectable (operable). The cancel button 1807 is a button to be selected in a cancellation of the operation for setting job separator sheets (input operation performed on the job separator sheet setting change screen 1801). The OK button 1808 is a button to be selected to finalize the operation for setting job separator sheets (input operation performed on the job separator sheet setting change screen 1801).

In a case where the CPU 202 detects that one of the sheet feed stage selection buttons 1803 to 1805 is selected by the user and the OK button 1808 for finalizing the change in the job separator sheet settings is selected, the processing returns to the foregoing step S1603. For example, in a case where, in step S1609, the unreserved sheet feed cassette 3 (104) is selected using the sheet feed stage selection button 1804, then in step S1603, the CPU 202 determines that the sheet feed stage where job separator sheets are set is not a reserved sheet feed stage (NO in step S1603). The processing thus proceeds to step S1605, and a sheet held in the sheet feed cassette 104 is fed and discharged as a separator sheet.

In a case where the abort button 1707 for aborting the execution of the print job is selected, then in step S1608, the CPU 202 determines that the user instruction is the foregoing operation (II) (NO in step S1608).

In such a case, the print processing itself ends.

In the present exemplary embodiment, the job separator sheet feed error screen 1701 is described to be displayed on the operation display unit 210 in a case where the determination result of step S1604 indicates that the print job about which the setting information is obtained in step S1601 is not a print job that uses a reserved sheet feed stage. However, such processing is not necessarily needed. For example, the determination of step S1604 can be omitted. In such a case, in a case where the determination result of step S1603 indicates that the sheet feed stage where job separator sheets are set is a reserved sheet feed stage (YES in step S1603), the processing can proceed to step S1606. In a case where the determination result of step S1603 indicates NO (NO in step S1603), the processing can proceed to step S1605. The job separator sheet feed error screen 1701 to be displayed in step S1606 in a case where the sheet feed stage where job separator sheets are set is a reserved sheet feed stage can display a button for instructing the discharge of a job separator sheet in addition to the abort button 1707 and the separator sheet setting change button 1708.

### (Sheet Feed Determination Processing)

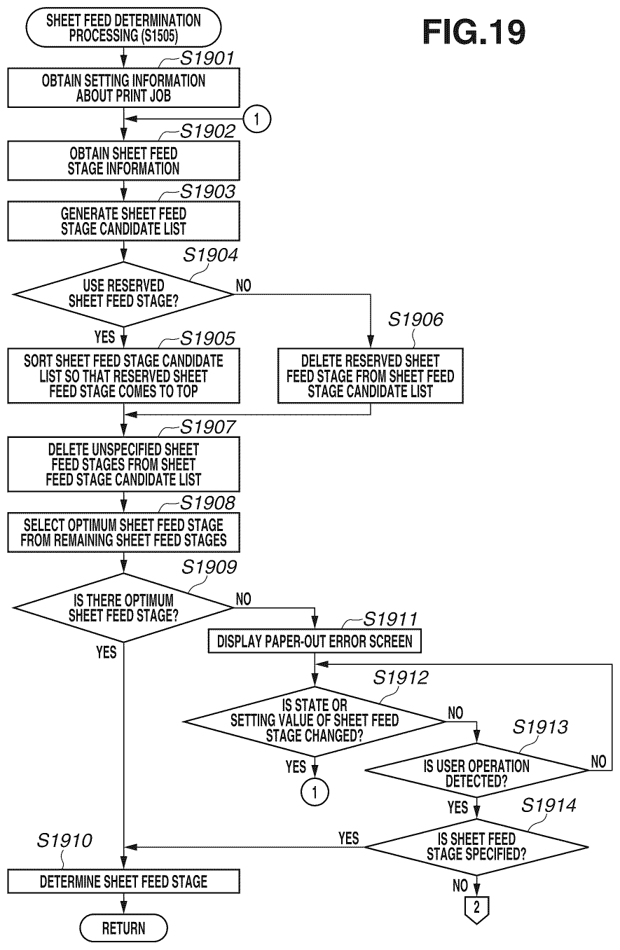

Next, an example of the sheet feed determination processing in step S1505 of FIG. 15 will be described with reference to the flowchart of FIG. 19.

When the sheet feed determination processing is started, in step S1901, the CPU 202 obtains the setting information about the print job, stored in the storage unit 205. The setting information about the print job is stored in the storage unit 205 by the processing of step S1402. As described above, the setting information about the print job includes the size of sheets for printing, the sheet type, the sheet feed stage setting information, and the setting information about whether to use a reserved sheet feed stage. The sheet feed stage where job separator sheets are set and a sheet feed stage where other sheets are set can be different sheet feed stages or the same sheet feed stage.

In step S1902, the CPU 202 obtains the sheet feed stage information stored in the storage unit 205. The sheet feed stage information refers to the setting information about each sheet feed stage, illustrated in Table 2.

In step S1903, the CPU 202 duplicates the sheet feed information obtained in step S1902 as a sheet feed stage candidate list. The sheet feed stage candidate list is used to determine sheet feed stages to be sheet feed candidates in the subsequent processing.

In step S1904, the CPU 202 determines whether the print job uses a reserved sheet feed stage, based on the setting information about whether to use a reserved sheet feed stage included in the setting information about the print job obtained in step S1901. In a case where the determination result of step S1904 indicates that the print job uses a reserved sheet feed stage (YES in step S1904), the processing proceeds to step S1905. In step S1905, the CPU 202 performs sorting of the sheet feed stages in the sheet feed stage candidate list generated in step S1903 so that a sheet feed stage in a reserved state (reserved sheet feed stage) comes to the top of the sheet feed stage candidate list. This enables the reserved sheet feed stage to be selected by priority in the selection of an optimum sheet feed stage to be described below (step S1908). When the processing of step S1905 is completed, the processing proceeds to step S1907 to be described below.

On the other hand, in a case where the determination result of step S1904 indicates that the print job does not use a reserved sheet feed stage (NO in step S1904), the processing proceeds to step S1906. In step S1906, the CPU 202 deletes a reserved sheet feed stage among the sheet feed stages in the sheet feed stage candidate list from the sheet feed stage candidate list. For example, in a case where the reservation statuses of the sheet feed stages are as illustrated in Table 2 and the print job is set to not use a reserved sheet feed stage, the CPU 202 deletes the sheet feed cassette 1 (102) from the sheet feed stage candidate list. In other words, in a case where a sheet feed stage specified by the print job is reserved and the print job does not include the setting information to use the reserved sheet feed stage, the print job is not executed using the sheet in the sheet feed stage. When the processing of step S1906 is completed, the processing proceeds to step S1907.

As described above, in a case where the determination result of step S1904 indicates that the print job uses a reserved sheet feed stage (YES in step S1904), no sheet feed stage will be deleted from the sheet feed candidate list. The sheet feed stage in the reserved state can thus feed sheets only for print jobs that are set to use a received sheet feed stage.

In step S1907, the CPU 202 identifies the sheet feed stage specified as a sheet source by referring to the sheet feed stage setting information included in the setting information about the print job obtained in step S1901. The CPU 202 then deletes the sheet feed stages other than the one specified as the sheet source from the sheet feed stage candidate list. The sheet feed stage setting information is the information specified in the sheet feed stage setting field 1205 (also see step S1104 of FIG. 11). In a case where a specific sheet feed stage is specified in the sheet feed stage setting field 1205, the CPU 202 deletes the sheet feed stages other than the one specified as the sheet source from the sheet feed stage candidate list. In a case where “auto” is set in the sheet feed stage setting field 1205, the CPU 202 does not delete any sheet feed stage from the sheet feed stage candidate list.

In step S1908, the CPU 202 selects an optimum sheet feed stage from the sheet feed stages remaining in the sheet feed stage candidate list. For example, the CPU 202 searches for a sheet feed stage where sheets matching the sheet size and sheet type included in the setting information about the print job are held, in order from the top of the sheet feed stage candidate list.

In step S1909, the CPU 202 determines whether there is a sheet feed stage where sheets optimum for printing are held based on the search result of step S1908. In a case where the determination result of step S1909 indicates that there is a sheet feed stage where sheets optimum for printing are held (YES in step S1909), the processing proceeds to step S1910. In step S1910, the CPU 202 determines the sheet feed stage as the sheet feed stage to feed sheets. When the processing of step S1910 is completed, the sheet feed determination processing ends.

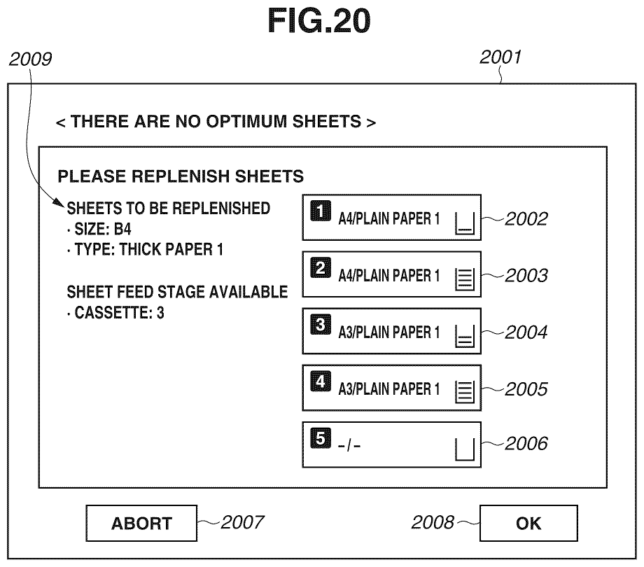

On the other hand, in a case where the determination result of step S1909 indicates that there is no sheet feed stage where sheets optimum for printing are held (NO in step S1909), the processing proceeds to step S1911. In step S1911, the CPU 202 displays a paper-out error screen 2001 illustrated in FIG. 20 on the operation display unit 210. FIG. 20 illustrates a case where the paper-out error screen 2001 includes sheet feed stage selection buttons 2002 to 2006, an abort button 2007, an OK button 2008, and an error resolution guidance display field 2009. For example, the error resolution guidance display field 2009 displays information (size and type) about sheets for continuing the print job and information indicating a sheet feed stage where the sheets can be loaded. When displaying the paper-out error screen 2001 on the operation display unit 210, the CPU 202 searches the sheet feed stage candidate list processed in step S1907 for a sheet feed stage where the sheets can be loaded.

The present exemplary embodiment deals with a case where the user can perform one of the following operations (III) to (V) based on the error resolution guidance display field 2009:
(III) Load the sheet feed stage displayed in the error resolution guidance display field 2009 with the sheets displayed in the error resolution guidance display field 2009 to resolve the paper-out error;
(IV) Select one of the sheet feed stage selection buttons 2002 to 2006 to forcibly continue the processing (print job) using sheets different from those displayed in the error resolution guidance display field 2009; and
(V) Press the abort button 2007 to abort the print job.

In step S1912, the CPU 202 waits for the user to perform one of the foregoing operations (III) to (V). In a case where one of the foregoing operations (III) to (V) is performed by the user and at least either the state or the setting value of a sheet feed stage is changed (YES in step S1912), the processing returns to step S1902 since sheets might have been loaded by the user. In step S1902, the CPU 202 searches for an optimum sheet feed stage again.

In a case where there is a change in the state of a sheet feed stage (YES in step S1912), the CPU 202 can display the setting selection screen 601 illustrated in FIG. 6 and the sheet setting screen 701 illustrated in FIG. 7 on the operation display unit 210. In such a case, the processing can proceed to step S1902 after the sheet settings (for example, the foregoing sheet feed stage information) are changed based on the user operation on the sheet setting screen 701. In a case where the sheet type does not need to be changed, the setting selection screen 601 illustrated in FIG. 6 and the sheet setting screen 701 illustrated in FIG. 7 do not need to be displayed.

On the other hand, in a case where there is no change in the state or setting value of any sheet feed stage (NO in step S1912), the processing proceeds to step S1913. In step S1913, the CPU 202 determines whether a user operation based on the error resolution guidance display field 2009 is detected. In a case where the determination result of step S1913 indicates that no user operation based on the error resolution guidance display field 2009 is detected (NO in step S1913), the processing returns to step S1912. On the other hand, in a case where the determination result of step S1913 indicates that a user operation based on the error resolution guidance display field 2009 is detected (YES in step S1913), the processing proceeds to step S1914.

In step S1914, the CPU 202 determines the input of the user operation based on the button selected on the paper-out error screen 2001. In a case where one of the sheet feed stage selection buttons 2002 to 2006 is selected and the OK button 2008 is then selected (YES in step S1914), the processing proceeds to the foregoing step S1910. In step S1910, the CPU 202 determines the sheet feed stage corresponding to the sheet feed stage selection button selected by the user among the sheet feed stage selection buttons 2002 to 2006 as the sheet feed stage to feed sheets. When the processing of step S1910 is completed, the sheet feed determination processing ends. On the other hand, in a case where the abort button 2007 is selected (NO in step S1914), the print processing itself ends.

As described above, according to the present exemplary embodiment, the image forming apparatus 100 enables changing the sheet feed stage for job separator sheets during a print job in a case where the sheet feed stage to be used as the sheet feed stage for job separator sheets is reserved and the print job is set to not use a reserved sheet feed stage. The print job can thereby be continued. In a printing environment where print sheets for office documents and special print sheets are both used, situations where office documents are unable to be printed can be prevented while avoiding the erroneous use of the special print sheets.

Next, a second exemplary embodiment will be described. In the first exemplary embodiment, the sheet feed stage that is specified as the sheet feed stage for job separator sheets by a print job is described to be able to be switched from a reserved sheet feed stage to an unreserved sheet feed stage during the execution of the print job. In contrast, the present exemplary embodiment deals with a case where the reservation state of the sheet feed stage where job separator sheets are loaded is cancelled without changing the sheet feed stage specified as the sheet feed stage for job separator sheets by the print job. The main difference between the present exemplary embodiment and the first exemplary embodiment thus lies in the processing for continuing the print job. In the description of the present exemplary embodiment, parts similar to those of the first exemplary embodiment are therefore denoted by the same reference numerals as in FIGS. 1A to 20. A detailed description thereof will be omitted.

Differences between the present exemplary embodiment and the first exemplary embodiment lie in the processing of steps S1606 to S1609 in FIG. 16 described above. More specifically, the job separator sheet feed error screen 1701 displayed in step S1606 and the job separator sheet setting change screen 1801 displayed in step S1609 are different. The rest of the processing is similar to that of the first exemplary embodiment. The differences from the first exemplary embodiment will therefore be mainly described.

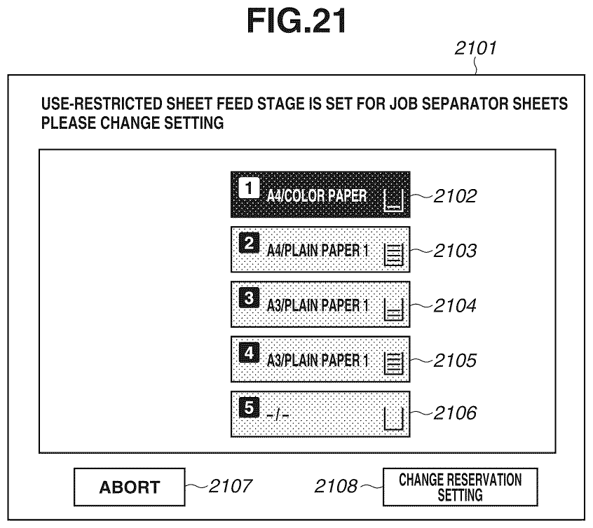

FIG. 21 is a diagram illustrating an example of a job separator sheet feed error screen 2101 displayed in step S1606. The job separator sheet feed error screen 2101 illustrated in FIG. 21 and the job separator sheet feed error screen 1701 illustrated in FIG. 17 described above differ in that the separator sheet setting change button 1708 is replaced with a reservation setting change button 2108. The reservation setting change button 2108 is a button for changing the reservation states of the sheet feed stages.

The present exemplary embodiment deals with a case where the user can perform one of the following operations (VI) or (VII) on the job separator sheet feed error screen 2101 in step S1606: (VI) Select the reservation setting change button 2108 to cancel the reservation state of the reserved sheet feed stage and instruct continuation of the print job, considering that the reserved sheet feed stage is erroneously specified as the sheet feed stage for job separator sheets; and (VII) Select the abort button 2107 to abort the execution of the print job.

In step S1607, the CPU 202 waits for the user to select the abort button 2107 or the reservation setting change button 2108. In a case where the selection of the abort button 2107 or the reservation setting change button 2108 is detected (YES in step S1607), the processing proceeds to step S1608. In step S1608, the CPU 202 determines the input of the user operation based on the button selected on the job separator sheet feed error screen 2101.

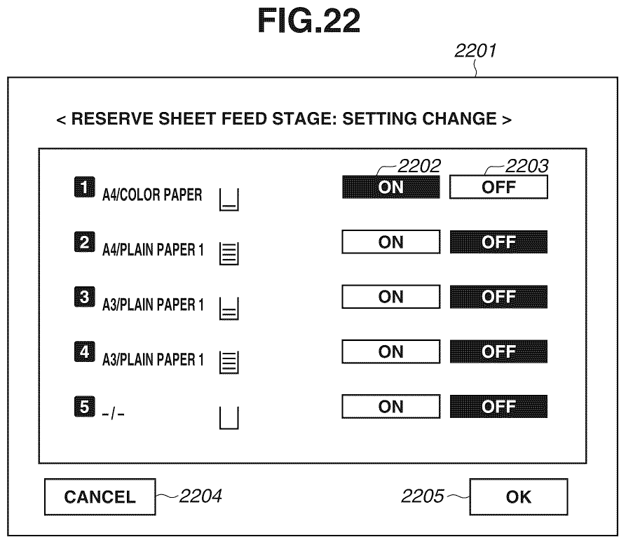

In a case where the reservation setting change button 2108 is selected, the processing proceeds to step S1609. In step S1609, the CPU 202 displays a sheet feed stage reservation setting change screen 2201 illustrated in FIG. 22 on the operation display unit 210. The sheet feed stage reservation setting change screen 2210 illustrated in FIG. 22 has a screen configuration similar to that of the sheet feed stage reservation setting screen 801 illustrated in FIG. 8. The sheet feed stage reservation setting change screen 2201 illustrated in FIG. 22 includes the phrase “: setting change” in the title of the setting menu, indicating to the user that the already set reserved sheet feed stage can be changed.

The CPU 202 can set and change the reservation states of the sheet feed stages based on the user's input operations on the sheet feed stage reservation setting change screen 2201. In a case where an OK button 2205 for finalizing the reservation change is selected by the user, the processing proceeds to step S1603. For example, in a case where, in step S1609, the use reservation of the sheet feed cassette 102 where job separator sheets are set is cancelled by selecting the reservation OFF button 2203, then in step S1603, the sheet feed stage where job separator sheets are set is determined to not be a reserved sheet feed stage (NO in step S1603). The processing thus proceeds to the foregoing step S1605, and a sheet held in the sheet feed cassette 104 is fed and discharged as a job separator sheet.

In the present exemplary embodiment, a description will be given of a case where, in a case where the reservation state of each sheet feed stage is changed as described above, the reservation state can be changed again using the sheet feed stage reservation setting screen 801 or the sheet feed stage reservation setting change screen 2201. In a case where the reservation state is changed again using the sheet feed stage reservation setting screen 801 or the sheet feed stage reservation setting change screen 2201, the reservation state of the sheet feed stage is restored to the unchanged state (reserved state). However, this is not restrictive.

For example, the change performed to the reservation state of the sheet feed stage using the sheet feed stage reservation setting change screen 2201 can be a temporary one (for example, a change effective only for the print job where the reservation state of the sheet feed stage is changed).

As described above, according to the present exemplary embodiment, the image forming apparatus 100 cancels the reservation of the reserved sheet feed stage in a case where the sheet feed stage to be used as the sheet feed stage for job separator sheets is reserved and the print job is set to not use the reserved sheet feed stage. The print job can thereby be continued. This can prevent situations where office documents are unable to be printed.

Next, a third exemplary embodiment will be described. The first and second exemplary embodiments have dealt with the case where the print job is continued by changing the sheet feed stage specified as the sheet feed stage for job separator sheets by the print job or changing the reservation state of the sheet feed stage. The present exemplary embodiment deals with a case where the print job is continued without changing the job separator sheet settings. The main difference between the present exemplary embodiment and the first and second exemplary embodiments thus lies in the processing for continuing the print job. In the description of the present exemplary embodiment, parts similar to those of the first and second exemplary embodiments are therefore denoted by the same reference numerals as in FIGS. 1A to 22. A detailed description thereof will be omitted.

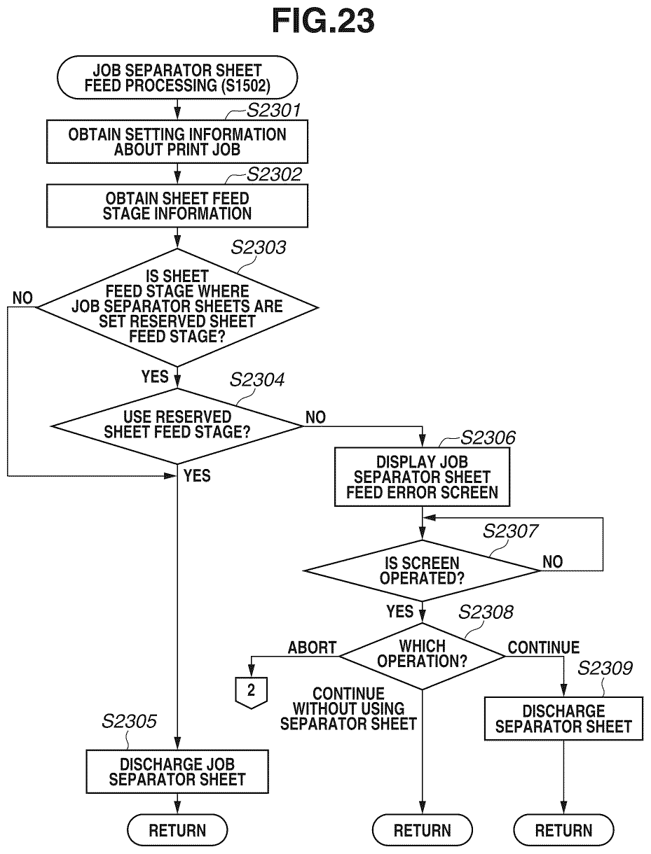

FIG. 23 is a flowchart for describing an example of the job separator sheet feed processing (step S1502). Differences between the job separator sheet feed processing according to the first and second exemplary embodiments (FIG. 16) and the job separator sheet feed processing illustrated in FIG. 23 lie in the processing of step S1606 and the subsequent steps in FIG. 16. The processing of step S1606 and the subsequent steps in FIG. 16 is replaced with the processing of step S2306 and the subsequent steps in FIG. 23. The rest of the job separator sheet feed processing is similar to the job separator sheet feed processing (FIG. 16) according to the first and second exemplary embodiments (steps S2301 to S2305 of FIG. 23 are similar to steps S1601 to S1605 of FIG. 16). The differences from the first and second exemplary embodiments will therefore be mainly described.

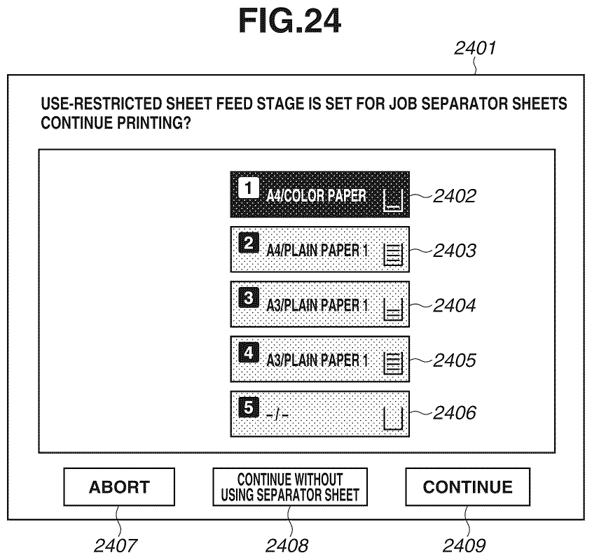

In step S2306, the CPU 202 displays a job separator sheet feed error screen 2401 illustrated in FIG. 24 on the operation display unit 210. FIG. 24 illustrates a case where the job separator sheet feed error screen 2401 includes sheet feed stage selection buttons 2402 to 2406, an abort button 2407, a continue without separator sheet button 2408, and a force continue button 2409. The sheet feed stage selection buttons 2402 to 2406 are similar to the sheet feed stage selection buttons 1702 to 1706 illustrated in FIG. 17. Like FIG. 17, FIG. 24 illustrates a case where the sheet feed stage selection button 2402 for selecting the sheet feed cassette 1 (102) is grayed out to indicate inoperability.

Like the abort button 1707 illustrated in FIG. 17, the abort button 2407 in FIG. 24 is a button for aborting the print job.

The continue without separator sheet button 2408 is a button for continuing the print job without using a separator sheet.

The force continue button 2409 is a button for continuing the print job using the separator sheets held in the reserved sheet feed stage.

In step S2307, the CPU 202 waits for the user to select one of the abort button 2407, the continue without separator sheet button 2408, or the force continue button 2409. In a case where one of the abort button 2407, the continue without separator sheet button 2408, or the force continue button 2409 is detected to be selected (YES in step S2307), the processing proceeds to step S2308. In step S2308, the CPU 202 determines the input of the user operation based on the button selected on the job separator sheet feed error screen 2401.

In a case where the continue without separator sheet button 2408 is selected (CONTINUE WITHOUT USING SEPARATOR SHEET in step S2308), the job separator sheet feed processing ends without the CPU 202 issuing instructions to feed or discharge a separator sheet. In such a case, no partition sheet is fed or discharged. In a case where the force continue button 2409 is selected (CONTINUE in step S2308), the processing proceeds to step S2309. In step S2309, the CPU 202 feeds a sheet held in the reserved sheet feed stage where job separator sheets are set as a job separator sheet. The printer engine 110 discharges the sheet fed from the sheet feed stage to the discharge tray 107. Print jobs that do not use a reserved sheet feed stage are generally unable to use the sheets held in the reserved sheet feed stage. However, the present exemplary embodiment deals with a case where the use of the reserved sheet feed stage is exceptionally permitted to continue the print job by selecting the force continue button 2409. In such a case, the use of the reserved sheet feed stage is prohibited again once the print job ends. In a case where the abort button 2407 is selected (ABORT in step S2308), the print processing itself ends.

As described above, according to the present exemplary embodiment, the image forming apparatus 100 executes the print job without using separator sheets in a case where the sheet feed stage used as the sheet feed stage for job separator sheets is reserved and the print job is set to not use the reserved print job. Alternatively, in a case where the sheet feed stage used as the sheet feed stage for job separator sheets is reserved and the print job is set to not use the reserved print job, the image forming apparatus 100 can temporarily permit the use of the sheet feed stage. The print job can thereby be continued. This can prevent situations where office documents are unable to be printed.

Next, a fourth exemplary embodiment will be described. The present exemplary embodiment deals with a specific example of the setting to reserve a sheet feed stage for use and the job separator sheet settings according to the first to third exemplary embodiments. In the description of the present exemplary embodiment, parts similar to those of the first to third exemplary embodiments are therefore denoted by the same reference numerals as in FIGS. 1A to 24. A detailed description thereof will be omitted.

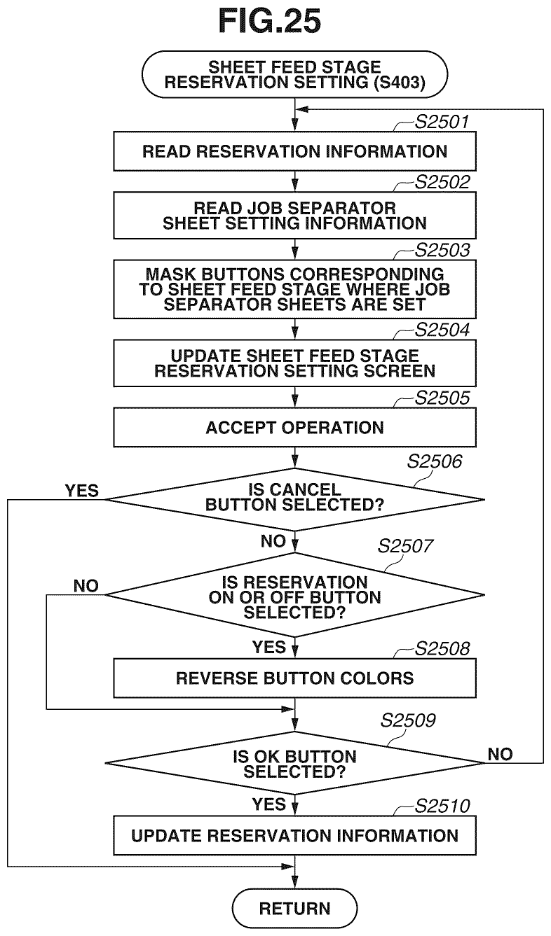

FIG. 25 is a flowchart for describing an example of sheet feed stage reservation setting processing.

In step S2501, the CPU 202 reads currently set reservation information about the sheet feed stages. In the example of the first exemplary embodiment, the reservation information about each sheet feed stage is stored as a reservation state in Tables 1 and 2.

In step S2502, the CPU 202 reads job separator sheet setting information being set when this step is executed. The job separator sheet setting information refers to the information set based on the user operation on the separator sheet feed location setting screen 1001 illustrated in FIG. 10, for example.

In step S2503, the CPU 202 masks the reservation ON button and the reservation OFF button corresponding to the sheet feed stage where job separator sheets are set, with the reservation OFF button of this sheet feed stage selected. An example of the reservation ON button and the reservation OFF button will be described below.

In step S2504, the CPU 202 updates the sheet feed stage reservation setting screen based on the processing results of steps S2501 to S2503.

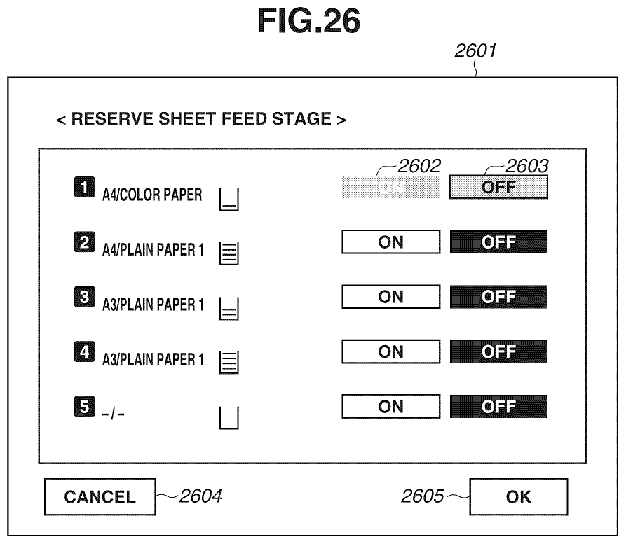

FIG. 26 is a diagram illustrating an example of a sheet feed stage reservation setting screen 2601 displayed in step S2504. FIG. 26 illustrates a case where the sheet feed stage in which job separator sheets are set is the sheet feed cassette 1 (102).

A difference between the sheet feed stage reservation setting screen 2601 illustrated in FIG. 26 and the sheet feed stage reservation setting screen 801 illustrated in FIG. 8 will be described. In the sheet feed stage reservation setting screen 2601, a reservation ON button 2602 and a reservation OFF button 2603 corresponding to the sheet feed cassette 1 (102) where job separator sheets are set are displayed with shading due to the processing of step S2503. The shading indicates that the buttons are unable to be operated (selected). With the reservation ON button 2602 and the reservation OFF button 2603 shaded, the user is unable to reserve the sheet feed cassette 1 (102) for use (change the sheet feed cassette 1 from an unreserved state to a reserved state).

In step S2505, the CPU 202 accepts operation on the sheet feed stage reservation setting screen 2601 (button).

In step S2506, the CPU 202 determines whether the operation accepted in step S2505 is the selection of a cancel button 2604. In a case where the determination result of step S2506 indicates that the operation accepted in step S2505 is the selection of the cancel button 2604 (YES in step S2506), the processing of the flowchart of FIG. 25 ends.

On the other hand, in a case where the determination result of step S2506 indicates that the operation accepted in step S2505 is not the selection of the cancel button 2604 (NO in step S2506), the processing proceeds to step S2507. In step S2507, the CPU 202 determines whether the operation accepted in step S2505 is the selection of a reservation ON button 2602 or reservation OFF button 2603. In a case where the determination result of step S2507 indicates that the operation accepted in step S2505 is not the selection of a reservation ON button 2602 or reservation OFF button 2603 (NO in step S2507), the processing of step S2508 is skipped and the processing proceeds to step S2509.

In a case where the determination result of step S2507 indicates that the operation accepted in step S2505 is the selection of a reservation ON button 2602 or reservation OFF button 2603 (YES in step S2507), the processing proceeds to step S2508. In step S2508, the CPU 202 reverses the color of the reservation ON button 2602 or reservation OFF button 2603 selected and that of the reservation OFF button 2603 or reservation ON button 2602 paired with the selected reservation ON button 2602 or reservation OFF button 2603 between black and white. Note that the CPU 202 does not accept the selection of the reservation ON button 2602 or reservation OFF button 2603 masked in step S2503 and displayed with shading in FIG. 26. In a case where such a reservation ON button 2602 or reservation OFF button 2603 is selected, the processing of step S2508 (switching of drawing colors) is not performed.

In step S2509, the CPU 202 determines whether the operation accepted in step S2505 is the selection of an OK button 2605. In a case where the determination result of step S2509 indicates that the operation accepted in step S2505 is not the selection of the OK button 2605 (NO in step S2509), the processing returns to step S2501. On the other hand, in a case where the operation accepted in step S2505 is the selection of the OK button 2605 (YES in step S2509), the processing proceeds to step S2510. In step S2510, the CPU 202 updates the reservation information by reflecting the reservation states indicated by the reservation ON buttons 2602 and the reservation OFF buttons 2603 of the respective sheet feed stages at the time of execution of this step upon the reservation information. When the processing of step S2510 is completed, the processing of the flowchart of FIG. 25 ends.

By the foregoing processing of the flowchart of FIG. 25, the sheet feed stage where job separator sheets are loaded can be prevented from being set as a reserved sheet feed stage.

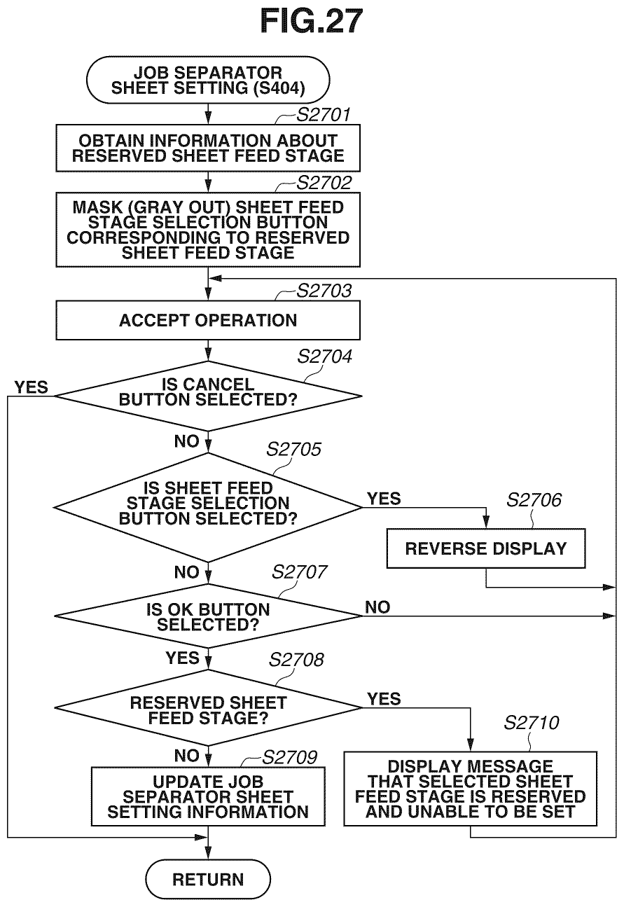

FIG. 27 is a flowchart for describing an example of job separator sheet setting processing.

In step S2701, the CPU 202 obtains information about the reserved sheet feed stage.

In step S2702, the CPU 202 masks the sheet feed stage selection button corresponding to the reserved sheet feed stage.

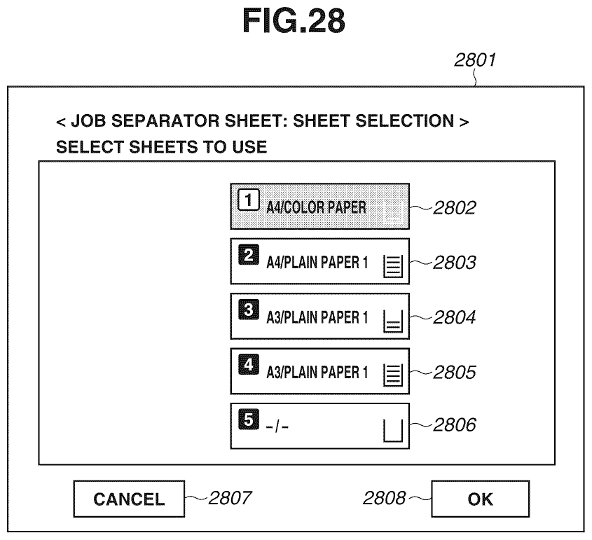

FIG. 28 is a diagram illustrating an example of a job separator sheet setting screen 2801. The job separator sheet setting screen 2801 is displayed, for example, when the sheet feed stage setting button 904 on the job separator sheet setting screen 901 illustrated in FIG. 9 is selected.

Here, an example where a sheet feed stage selection button 2802 corresponding to the sheet feed cassette 1 (102) is masked (grayed out) and the sheet feed cassette 1 (102) is unable to be selected as the sheet feed cassette for feeding job separator sheets will be described.

In step S2703, the CPU 202 accepts a user operation on the job separator sheet setting screen 2801 (button).

In step S2704, the CPU 202 determines whether the operation accepted in step S2703 is the selection of a cancel button 2807. In a case where the determination result of step S2704 indicates that the operation accepted in step S2703 is the selection of the cancel button 2807 (YES in step S2704), the processing of the flowchart of FIG. 27 ends.

On the other hand, in a case where the determination result of step S2704 indicates that the operation accepted in step S2703 is not the selection of the cancel button 2807 (NO in step S2704), the processing proceeds to step S2705. In step S2705, the CPU 202 determines whether the operation accepted in step S2703 is the selection of one of sheet feed stage selection buttons 2803 to 2806. In a case where the determination result of step S2705 indicates that the operation accepted in step S2703 is the selection of one of the sheet feed stage selection buttons 2803 to 2806 (YES in step S2705), the processing proceeds to step S2706. In step S2706, the CPU 202 reverses the display color of the sheet feed stage selection button selected among the sheet feed stage selection buttons 2803 to 2806. The processing returns to step S2703.

On the other hand, in a case where the determination result of step S2705 indicates that the operation accepted in step S2703 is not the selection of any of the sheet feed stage selection buttons 2803 to 2806 (NO in step S2705), the processing proceeds to step S2707. In step S2707, the CPU 202 determines whether the operation accepted in step S2703 is the selection of an OK button 2808. In a case where the determination result of step S2707 indicates that the operation accepted in step S2703 is not the selection of the OK button 2808 (NO in step S707), the processing returns to step S2703.

On the other hand, in a case where the determination result of step S2707 indicates that the operation accepted in step S2707 is the selection of the OK button 2808 (YES in step S2707), the processing proceeds to step S2708. In step S2708, the CPU 202 determines whether the sheet feed stage corresponding to the sheet feed stage selection button being selected when this step is executed among the sheet feed stage selection buttons 2803 to 2806 is a reserved sheet feed stage.

In a case where the determination result of step S2708 indicates that the sheet feed stage corresponding to the sheet feed stage selection button being selected when step S2707 is executed is not a reserved sheet feed stage (NO in step S2708), the processing proceeds to step S2709. In step S2709, the CPU 202 updates the job separator sheet setting information by setting the sheets set in the sheet feed stage corresponding to the sheet feed stage selection button being selected when step S2707 is executed as job separator sheets. When the processing of step S2709 is completed, the flowchart of the flowchart of FIG. 27 ends.

On the other hand, in a case where the determination result of step S2708 indicates that the sheet feed stage corresponding to the sheet feed stage selection button being selected when step S2707 is executed is a reserved sheet feed stage (YES in step S2708), the processing proceeds to step S2710. In step S2710, the CPU 202 displays a message on the operation display unit 210 that the selected sheet feed stage is a reserved sheet feed stage and unable to be set as the sheet feed stage for feeding job separator sheets. The processing returns to step S2703.

By the processing of the flowchart of FIG. 27 described above, the sheets in the sheet feed stage set as a reserved sheet feed stage can be prevented from being set as job separator sheets.

The processing of the flowcharts of FIGS. 25 and 27 can prevent printing from being interrupted because the sheet feed stage where separator sheets are set is reserved for use. For example, the sheet feed stage where job separator sheets are set is prevented from being determined to be a reserved sheet feed stage in step S1603 of FIG. 16. This can prevent the interruption of printing due to a sheet feed error because the sheet feed stage where separator sheets are set is a reserved sheet feed stage.

Next, a fifth exemplary embodiment will be described. The present exemplary embodiment deals with a case where job separator sheet settings are set for a print job that uses a reserved sheet feed stage, separate from the job separator sheet settings described in the first exemplary embodiment. The present exemplary embodiment is applicable not only to the first exemplary embodiment but also to the second to fourth exemplary embodiments. In other words, the present exemplary embodiment is constituted by adding the configuration and processing for the job separator sheet settings for a print job that uses a reserved sheet feed stage to the first to fourth exemplary embodiments. In the description of the present exemplary embodiment, parts similar to those of the first to fourth exemplary embodiments are therefore denoted by the same reference numerals as in FIGS. 1A to 28. A detailed description thereof will be omitted. In the following description, a print job that uses a reserved sheet feed stage will be referred to as a reserved job where appropriate.

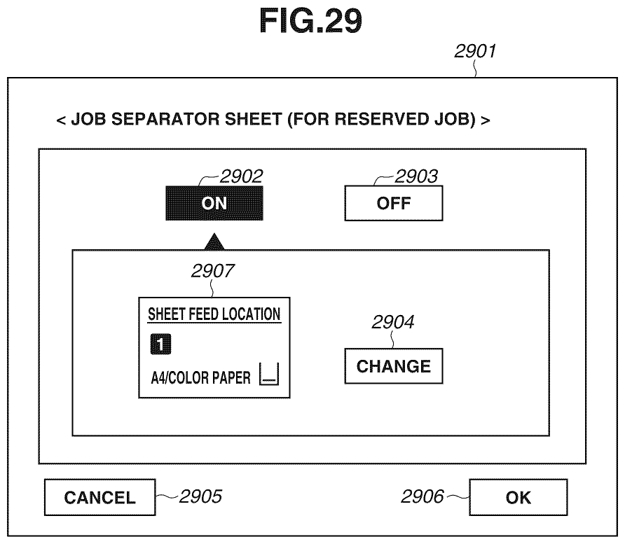

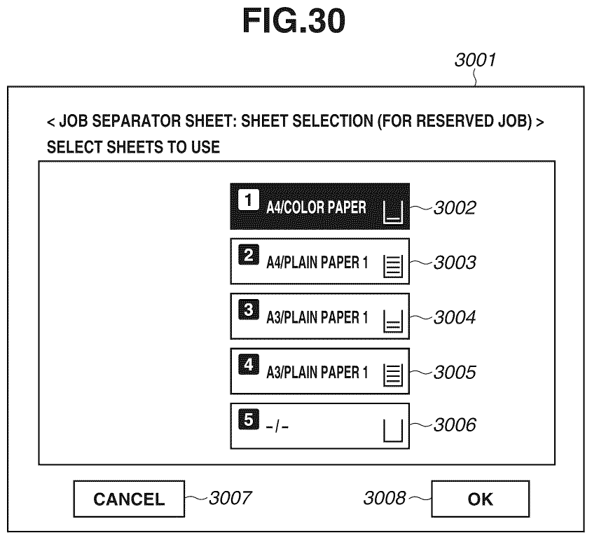

For example, the job separator sheet settings for a reserved job are implemented by using a job separator sheet setting screen 2901 and a separator sheet feed location setting screen 3001 illustrated in FIGS. 29 and 30.

For example, the job separator sheet setting screen 2901 and the separator sheet feed location setting screen 3001 illustrated in FIGS. 29 and 30 have a screen configuration similar to that of the job separator sheet setting screen 901 and the separator sheet feed location setting screen 1001 illustrated in FIGS. 9 and 10, respectively. The job separator sheet setting screen 2901 and the separator sheet feed location setting screen 3001 illustrated in FIGS. 29 and 30 include the phrase “for reserved job” in the titles of the setting menus. This phrase informs the user that settings different from those for normal job separator sheets can be set using the job separator sheet setting screen 2901 and the separator sheet feed location setting screen 3001.

The job separator sheet setting screen 2901 illustrated in FIG. 29 is displayed, for example, by selecting a not-illustrated setting selection button different from the setting selection buttons 602 to 604 on the setting selection screen 601 illustrated in FIG. 6. The not-illustrated setting selection button is a button to be selected when the user sets job separator sheet settings for a reserved job.

A setting ON button 2902 and a setting OFF button 2903 illustrated in FIG. 29 correspond to the setting ON button 902 and the setting OFF button 903 illustrated in FIG. 9, respectively. A sheet feed stage setting button 2904, a cancel button 2905, and an OK button 2906 illustrated in FIG. 29 correspond to the sheet feed stage setting button 904, the cancel button 905, and the OK button 906 illustrated in FIG. 9, respectively. A sheet feed stage current status display field 2907 illustrated in FIG. 29 corresponds to the sheet feed stage current status display field 907 illustrated in FIG. 9. In a case where the sheet feed stage setting button 2904 is selected, the separator sheet feed location setting screen 3001 illustrated in FIG. 30 is thus displayed.

Sheet feed stage selection buttons 3002 to 3006, a cancel button 3007, and an OK button 3008 illustrated in FIG. 30 correspond to the sheet feed stage selection buttons 1002 to 1006, the cancel button 1007, and the OK button 1008 illustrated in FIG. 10, respectively.

In the fourth exemplary embodiment, the job separator sheet setting processing is described to restrict settings so that the reserved sheet feed stage is unable to be set as the sheet feed stage for feeding job separator sheets (see step S2710). By contrast, in the present exemplary embodiment, the sheet feed stage that feeds job separator sheets for a reserved job can be set as a sheet feed stage for feeding job separator sheets regardless of the reservation state of the sheet feed stage.

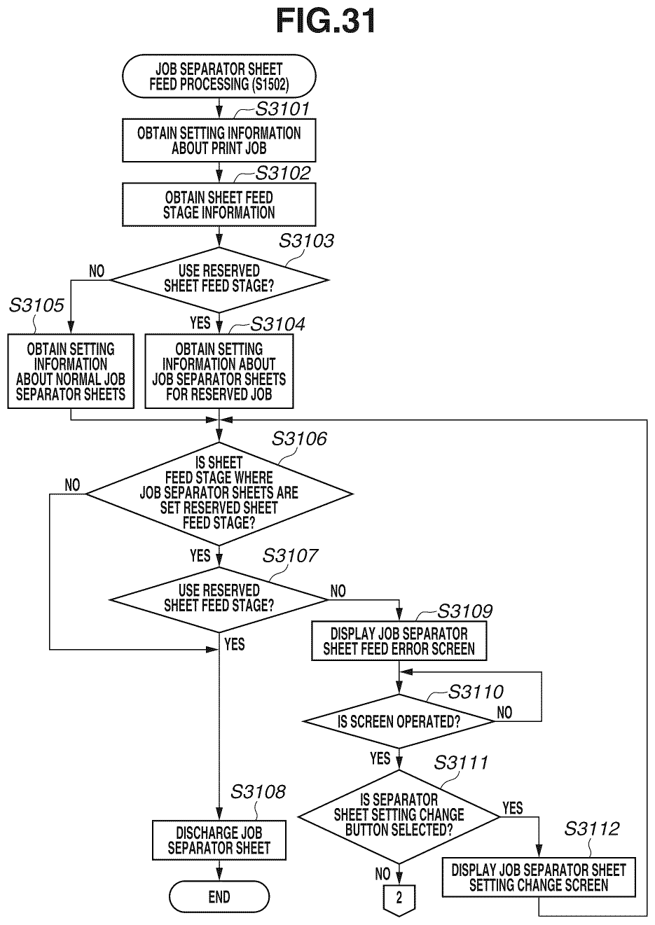

FIG. 31 is a flowchart for describing an example of the job separator sheet feed processing in the case of setting the job separator sheet settings for a reserved job.

The processing of steps S3101 and S3102 is similar to that of steps S1601 and S1602 in FIG. 16. A detailed description of the processing of steps S3101 and S3102 will thus be omitted here.

In steps S3103 to S3105, sheet feed stage information concerning job separator sheets is obtained depending on the setting about whether to use a reserved sheet feed stage.

In step S3103, the CPU 202 determines whether the print job uses a reserved sheet feed stage where job separator sheets are set based on the setting information about whether to use a reserved sheet feed stage, included in the setting information about the print job obtained in step S3101. In a case where the determination result of step S3103 indicates that the print job uses a reserved sheet feed stage where job separator sheets are set (YES in step S3103), the processing proceeds to step S3104. In step S3104, the CPU 202 obtains setting information about the job separator sheets for the reserved job. An example of the setting information about the job separator sheets for the reserved job is the information that is set based on user operations on the job separator sheet setting screen 2901 and the separator sheet feed location setting screen 3001 illustrated in FIGS. 29 and 30. The processing then proceeds to step S3106.

On the other hand, in a case where the determination result of step S3103 indicates that the print job does not use a reserved sheet feed stage where job separator sheets are set (NO in step S3103), the processing proceeds to step S3105. In step S3105, the CPU 202 obtains setting information about normal job separator sheets. The normal job separator sheets refer to job separator sheets for print jobs other than reserved jobs. An example of the setting information about normal job separator sheets is the information that is set based on user operations on the job separator sheet setting screen 901 and the separator sheet feed location setting screen 1001 illustrated in FIGS. 9 and 10. The processing then proceeds to step S3106.

In step S3106, the CPU 202 determines whether the sheet feed stage where job separator sheets are set is a reserved sheet feed stage based on the setting information about the job separator sheets obtained in step S3104 or S3105 and the sheet feed stage information obtained in step S3102.

The processing of steps S3107 to S3112 is similar to that of steps S1604 to S1609 of FIG. 16. A detailed description of the processing of steps S3107 to S3112 will thus be omitted here.

In the present exemplary embodiment, the image forming apparatus 100 sets the job separator sheet settings for a reserved job aside from normal job separator sheet settings. This can avoid erroneous use of sheets and prevent printing from being stopped due to a feed error of a job separator sheet during execution of a print job that does not use a reserved sheet feed stage.

Next, a sixth exemplary embodiment will be described. The present exemplary embodiment deals with a case where a setting whether to exclude a sheet feed stage where job separator sheets are set from reservation can be set. The main difference between the present exemplary embodiment and the first to fifth exemplary embodiments thus lies in the configuration and processing for enabling the setting whether to exclude the sheet feed stage where job separator sheets are set from reservation. In the description of the present exemplary embodiment, parts similar to those of the first to fifth exemplary embodiments are therefore denoted by the same reference numerals as in FIGS. 1A to 31. A detailed description thereof will be omitted. The present exemplary embodiment is applicable to any of the first to fifth exemplary embodiments.

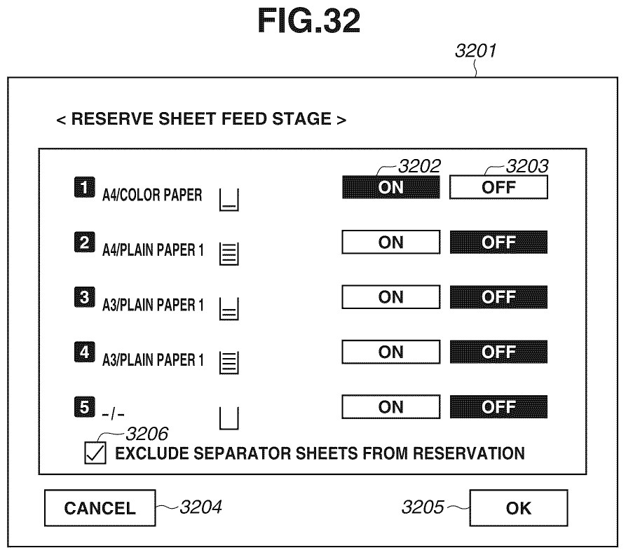

FIG. 32 is a diagram illustrating an example of a sheet feed stage reservation setting screen 3201. The sheet feed stage reservation setting screen 3201 is displayed in step S2504, for example.

The sheet feed stage reservation setting screen 3201 illustrated in FIG. 32 has a screen configuration such that a checkbox 3206 is added to the sheet feed stage reservation setting screen 2601 illustrated in FIG. 26. The checkbox 3206 is intended for the user to specify whether to exclude the sheet feed stage where job separator sheets are set from reservation. FIG. 32 illustrates a case where the checkbox 3206 is checked to set the sheet feed stage where job separator sheets to be excluded from reservation. Specifically, FIG. 32 illustrates a state where the checkbox 3206 is checked. Alternatively, the checkbox 3206 can be a checkbox to be checked to set the sheet feed stage where job separator sheets to be included as a reservation target.

Reservation ON buttons 3202 and reservation OFF buttons 3203 illustrated in FIG. 32 correspond to the reservation ON buttons 2602 and the reservation OFF buttons 2603 illustrated in FIG. 26, respectively.

A cancel button 3204 and an OK button 3205 illustrated in FIG. 32 correspond to the cancel button 2604 and the OK button 2605 illustrated in FIG. 26, respectively.

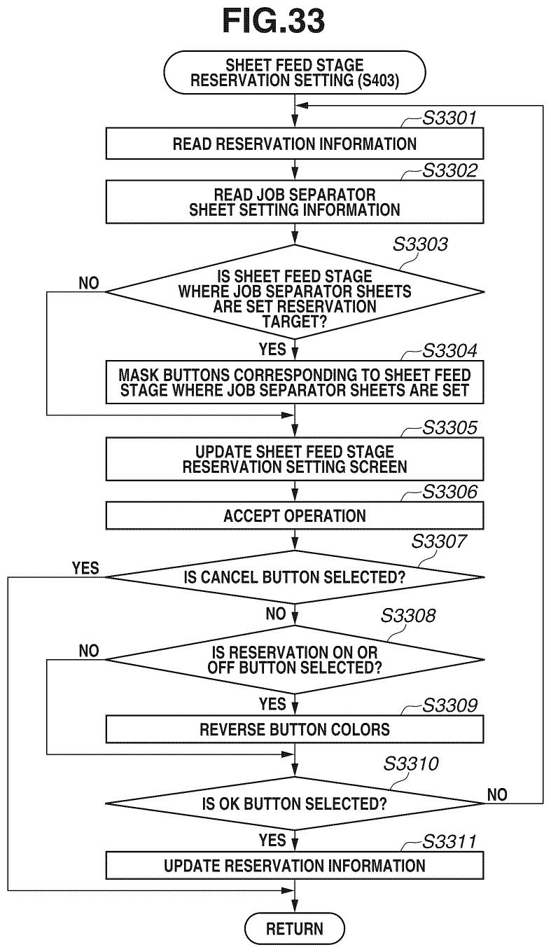

FIG. 33 is a flowchart for describing an example of the sheet feed stage reservation setting processing.

The processing of steps S3301 and S3302 is similar to that of steps S2501 and S2502 in FIG. 25. A detailed description of the processing of steps S3301 and S3302 will thus be omitted here.

In step S3303, the CPU 202 determines whether the sheet feed stage where job separator sheets are set is a reservation target.

As described above, in the present exemplary embodiment, in a case where the checkbox 3206 illustrated in FIG. 32 is not checked, the sheet feed stage where job separator sheets are set is determined to be a reservation target. On the other hand, in a case where the checkbox 3206 is checked, the sheet feed stage where job separator sheets are set is determined to be excluded from reservation.

In a case where the determination result of step S3303 indicates that the sheet feed stage where job separator sheets are set is a reservation target (YES in step S3303), the processing proceeds to step S3304. In step S3304, the CPU 202 masks the reservation ON button 3202 and the reservation OFF button 3203 corresponding to the sheet feed stage where job separator sheets are set, so that the sheet feed stage is unable to be selected. On the other hand, in a case where the determination result of step S3303 indicates that the sheet feed stage where job separator sheets are set is not a reservation target (NO in step S3303), the processing proceeds to step S3305 without masking the reservation ON button 3202 or the reservation OFF button 3203 (processing of step S3304).

The processing of steps S3305 to S3311 is similar to that of steps S2504 to S2510 in FIG. 25. A detailed description of steps S3305 to S3311 will thus be omitted here.

In the present exemplary embodiment, unlike the fourth exemplary embodiment, even the sheet feed stage where job separator sheets are set can be reserved for use in a case where the setting to exclude the sheet feed stage where job separator sheet are set from reservation is enabled.

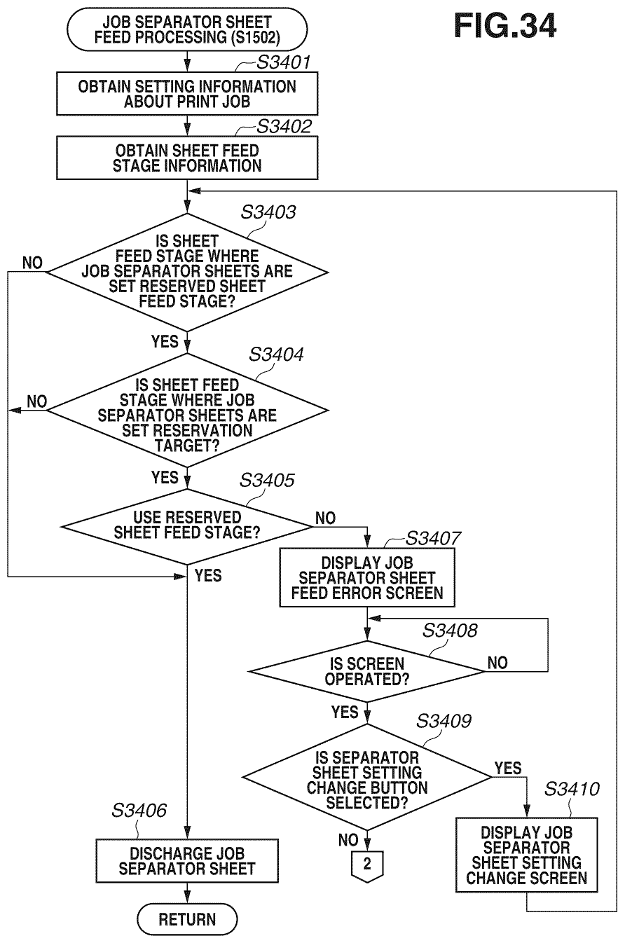

FIG. 34 is a flowchart for describing an example of job separator sheet feed processing using the setting whether to exclude the sheet feed stage where job separator sheets are set from reservation.

The processing of steps S3401 to S3403 is similar to that of steps S1601 to S1603 in FIG. 16. A detailed description of the processing of steps S3401 to S3403 will thus be omitted here.

In step S3404, the CPU 202 determines whether the sheet feed stage where job separator sheets are set is a reservation target based on the setting of the foregoing checkbox 3206. In a case where the determination result of step S3404 indicates that the sheet feed stage where job separator sheets are set is excluded from reservation (NO in step S3404), the processing proceeds to step S3406 regardless of the reservation setting of the print job (without performing the processing of step S3405). The processing of step S3406 is similar to that of step S1605. In step S3406, the CPU 202 thus feeds a sheet held in the sheet feed stage where job separator sheets are set as a job separator sheet (regardless of the reservation setting of the print job).

On the other hand, in a case where the determination result of step S3404 indicates that the sheet feed stage where job separator sheets are set is a reservation target (YES in step S3404), the processing proceeds to step S3405.

The processing of S3405 to S3410 is similar to that of steps S1604 to S1609 in FIG. 16. A detailed description of steps S3405 to S3410 will thus be omitted here.

As described above, according to the present exemplary embodiment, the image forming apparatus 100 enables the setting to exclude the sheet feed stage where job separator sheets are set from reservation. This can prevent printing from being stopped due to a feed error of a job separator sheet during execution of a print job that does not use a reserved sheet feed stage.

Unlike the fourth exemplary embodiment, the user can reserve the sheet feed stage where job separator sheets are set by excluding the sheet feed stage where job separator sheets are set from reservation. This facilitates restricting the use of sheet feed stages to prevent erroneous use of sheets for printing without restricting the use of job separator sheets.

In the exemplary embodiments, feed control on job separator sheets has been described. However, the insertion location of the separator sheets is not limited to between jobs. For example, the processing according to the exemplary embodiments can be similarly performed with other separator sheets, such as copy separator sheets to be inserted between copies. Second sheets to be fed separate from first sheets on which images are formed based on a print job (such as sheets constituting a document) are not limited to separator sheets, and can be front covers, interleaves, or chapter sheets. For example, the second sheets can be sheets that are set separate from the first sheets in a print job. The second sheets can be sheets held in a holding unit that is set as a holding unit to be used in the print job by print settings. In such a case, the print settings (print job) can set a holding unit for holding the first sheets and the holding unit for holding the second sheets separately. The print settings (print job) can set different holding units or the same holding unit as the holding unit for holding the first sheets and the holding unit for holding the second sheets. The first sheets and the second sheets can have different attributes (for example, in at least one of a type, thickness, or size) or the same attributes. The second sheets can be sheets fed at least one of the following timings: between one first sheet and another, immediately before a first sheet, or immediately after a first sheet. The second sheets are not limited to paper, and can be plastic films such as an OHP sheet, or cloth.

The exemplary embodiments have dealt with the cases where the change in reservation is simply from reserved to unreserved or from unreserved to reserved. However, the change in reservation is not limited to such a mode. For example, in a case where the use time slots of the sheet feed stages can be reserved, the change in reservation can include a change in the use time slots in addition to or instead of the foregoing mode where the presence or absence of a reservation is switched. In such a case, for example, use restriction can be lifted only for a time slot where the print job is executed during a reserved time slot, without cancelling the reservation.

According to an exemplary embodiment of the present disclosure, situations where print jobs become unable to continue can be prevented.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-155560, filed Sep. 21, 2023, which is hereby incorporated by reference herein in its entirety.

What is claimed is:

1. A printing apparatus comprising:
a sheet holding unit;
a first setting unit configured to set the sheet holding unit as a sheet feed source of a separator sheet;
a second setting unit configured to set a setting on the sheet holding unit to restrict use of a sheet held therein;
an execution unit configured to execute a print job; and
a display unit configured to, in a case where the execution unit executes the print job in a state where the setting by the second setting unit is set on the sheet holding unit set as the sheet feed source of the separator sheet by the first setting unit, display a screen configured to change the sheet feed source of the separator sheet.

2. The printing apparatus according to claim 1, wherein the first setting unit is configured to set the sheet holding unit as a sheet feed source of a print job separator sheet.

3. The printing apparatus according to claim 2, wherein the print job separator sheet is a separator sheet first output in the print job.

4. The printing apparatus according to claim 1,
wherein the execution unit is configured to, in a case where the sheet holding unit on which the setting is set by the second setting unit is specified as a sheet holding unit to be used for the print job and the print job includes predetermined information, execute the print job using the sheet held in the sheet holding unit, and
wherein the execution unit is configured to, in a case where the sheet holding unit on which the setting is set by the second setting unit is specified as the sheet holding unit to be used for the print job and the print job does not include the predetermined information, not execute the print job using the sheet held in the sheet holding unit.

5. The printing apparatus according to claim 1, wherein the execution unit is configured to, in a state where the screen is displayed, stop executing the print job.

6. The printing apparatus according to claim 5,
wherein the first setting unit is configured to, in a case where an object displayed on the screen is operated, set another sheet holding unit as the sheet feed source of the separator sheet, and
wherein the execution unit is configured to, in a case where the setting is not set on another sheet holding unit, resume executing the print job.

7. A printing apparatus comprising:
a sheet holding unit;
a first setting unit configured to set the sheet holding unit as a sheet feed source of a separator sheet;
a second setting unit configured to set a setting on the sheet holding unit to restrict use of a sheet held therein;
an execution unit configured to execute a print job; and
a display unit configured to, in a case where the execution unit executes the print job in a state where the setting by the second setting unit is set on the sheet holding unit set as the sheet feed source of the separator sheet by the first setting unit, display a screen configured to change the sheet holding unit to restrict the use of a sheet.

8. The printing apparatus according to claim 7, wherein the first setting unit is configured to set the sheet holding unit as a sheet feed source of a print job separator sheet.

9. The printing apparatus according to claim 8, wherein the print job separator sheet is a separator sheet first output in the print job.

10. The printing apparatus according to claim 7,
wherein the execution unit is configured to, in a case where the sheet holding unit on which the setting is set by the second setting unit is specified as a sheet holding unit to be used for the print job and the print job includes predetermined information, execute the print job using the sheet held in the sheet holding unit, and
wherein the execution unit is configured to, in a case where the sheet holding unit on which the setting is set by the second setting unit is specified as the sheet holding unit to be used for the print job and the print job does not include the predetermined information, not execute the print job using the sheet held in the sheet holding unit.

11. The printing apparatus according to claim 7, wherein the execution unit is configured to, in a state where the screen is displayed, not execute the print job.

12. The printing apparatus according to claim 11, wherein in a case where an object displayed on the screen is operated, the second setting unit sets the setting on another sheet holding unit and the execution unit resumes executing the print job.

13. A method for controlling a printing apparatus including a sheet holding unit, the method comprising:
setting the sheet holding unit as a sheet feed source of a separator sheet;
performing a setting on the sheet holding unit to restrict use of a sheet held therein;
executing a print job; and
displaying, in a case where the print job is executed in a state where the setting is set on the sheet holding unit set as the sheet feed source of the separator sheet, a screen configured to change the sheet feed source of the separator sheet.

14. A method for controlling a printing apparatus including a sheet holding unit, the method comprising:
setting the sheet holding unit as a sheet feed source of a separator sheet;
performing a setting on the sheet holding unit to restrict use of a sheet held therein;
executing a print job; and
displaying, in a case where the print job is executed in a state where the setting is set on the sheet holding unit set as the sheet feed source of the separator sheet, a screen configured to change the sheet holding unit to restrict the use of a sheet.
